(19) United States
(12) Patent Application Publication
(10) Pub. No.: US 2026/0278842 A1
(43) Pub. Date: Sep. 17, 2026

(54) SYSTEM AND METHOD FOR CALIBRATION OF A COMPONENT OF A HUMANOID ROBOT

(71) Applicant: Figure AI Inc., San Jose, CA (US)

(72) Inventors: Christopher Stathis, San Jose, CA (US); Louis Foucard, San Jose, CA (US); Hao Wu, San Jose, CA (US)

(21) Appl. No.: 19/568,750

(22) Filed: Mar. 16, 2026

Related U.S. Application Data
(60) Provisional application No. 63/772,440, filed on Mar. 14, 2025.

(51) Int. Cl. G06T 7/80; B25J 9/04; B25J 13/08; B25J 19/02; G06T 7/593; G06T 7/73

(52) U.S. Cl. CPC G06T 7/85; B25J 9/042; B25J 13/085; B25J 19/023; G06T 7/593; G06T 7/73; G06T 2207/10012; G06T 2207/30244

(57) ABSTRACT

A calibration system and method for calibrating one or more sensors contained in a component of a robot. A movement device separate from the robot is removably secured to the component and effects relative positioning between the component and a calibration fixture bearing a pattern of known geometry at a plurality of distinct poses. At each pose, sensor data is acquired from the one or more sensors and pose data indicative of a configuration of the movement device is recorded. A processing unit determines one or more calibration parameters based on a comparison between locations of pattern features as determined from the sensor data and known locations of the features on the calibration fixture, using the pose data to relate the sensor data across the distinct poses. The determined calibration parameters may be applied to a memory associated with the component, a memory associated with the robot, or a calibration database indexed by an identifier of the component or the robot.

### CROSS-REFERENCE TO RELATED APPLICATIONS

This application claims the benefit of and priority to U.S. Provisional Patent Application No. 63/772,440, filed on Mar. 14, 2025 which is incorporated by reference herein in its entirety.

### TECHNICAL FIELD

This disclosure relates to systems, methods, and techniques for calibrating a camera system, and more specifically for calibrating a camera system of a humanoid robot.

### BACKGROUND

Humanoid robots are complex mechanisms composed of numerous links and joints that form kinematic chains from a base to various end-effectors like hands and feet. The robot's control system depends on a kinematic model, which is a mathematical representation of its geometry, to calculate the joint angles required to position an end-effector at a desired location. However, discrepancies often exist between this theoretical model and the actual physical robot. These inaccuracies can stem from manufacturing tolerances, variations in assembly, and the wear of mechanical components over time. Such deviations can lead to significant errors in the robot's movements, resulting in failed tasks and potential collisions. Consequently, the use of a calibration process is essential. Yet, conventional calibration techniques present several technical challenges, require extensive setups, are often inefficient and error-prone. Therefore, there is a significant need for an improved calibration methodology.

### SUMMARY OF INVENTION

In one aspect, the present disclosure provides a calibration system for calibrating one or more sensors contained in a component of a robot. The calibration system comprises a calibration fixture having a surface bearing a pattern of known geometry, and a movement device that is separate from the robot and configured to be removably secured to the component of the robot, where the component includes one or more sensors coupled thereto. The calibration system further comprises a controller operatively coupled to the movement device, the controller configured to cause the movement device to effect relative positioning between the component and the calibration fixture at each of a plurality of distinct poses. The calibration system further comprises a processing unit communicatively coupled to the one or more sensors and to the movement device. The processing unit is configured to receive, at each of the plurality of distinct poses, sensor data captured by the one or more sensors while the component is at that pose, and pose data indicative of a configuration of the movement device at that pose. The processing unit is further configured to determine one or more calibration parameters of the one or more sensors based at least in part on a comparison between locations of features of the pattern as determined from the sensor data and known locations of the features on the calibration fixture, using the pose data to relate the sensor data across the plurality of distinct poses.

In another aspect, the present disclosure provides a method of calibrating one or more sensors contained in a component of a robot. The method comprises removably securing the component to a movement device that is separate from the robot, where the component includes one or more sensors coupled thereto. The method further comprises effecting, by the movement device, relative positioning between the component and a calibration fixture having a surface bearing a pattern of known geometry at a plurality of distinct poses, each pose placing at least a portion of the pattern within a field of view of at least one of the one or more sensors. At each of the plurality of distinct poses, the method includes acquiring sensor data from the one or more sensors and recording pose data indicative of a configuration of the movement device at that pose. The method further comprises determining, by a processing unit, one or more calibration parameters of the one or more sensors based at least in part on a comparison between locations of features of the pattern as determined from the sensor data and known locations of the features on the calibration fixture, using the pose data to relate the sensor data across the plurality of distinct poses. The method further comprises applying the determined one or more calibration parameters to at least one of: a memory associated with the component, a memory associated with the robot, or a calibration database indexed by an identifier of the component or the robot.

In certain embodiments, the component is a head of a humanoid robot and the one or more sensors comprise a plurality of cameras arranged in a plurality of distinct camera groups, each camera group having a respective field of view oriented in a different direction relative to the head. The plurality of distinct camera groups may include at least two of: eye cameras, chin-mounted cameras, top-mounted cameras, or rear-facing cameras. In such embodiments, the calibration fixture may comprise a plurality of planar surfaces arranged in distinct spatial zones, each spatial zone positioned to fall within the field of view of a respective one of the plurality of distinct camera groups such that, at each of the plurality of distinct poses, each camera group observes calibration pattern features on at least one planar surface within its corresponding spatial zone. In certain implementations, during the effecting of relative positioning, the component is moved through the plurality of distinct poses such that each camera group simultaneously observes calibration pattern features on at least one planar surface within its corresponding spatial zone. In some embodiments, at least two of the plurality of planar surfaces are arranged at approximately 90 degrees relative to each other and at least two other of the plurality of planar surfaces are arranged at approximately 135 degrees relative to each other.

In certain embodiments, the one or more sensors comprise at least one visual sensor and at least one depth sensor, and the processing unit is further configured to compute a three-dimensional reconstruction of the features of the pattern using depth data acquired from the at least one depth sensor and to incorporate the three-dimensional reconstruction into the determination of the one or more calibration parameters. The calibration fixture may comprise a plurality of surfaces, each surface bearing a respective pattern of known geometry, and each respective pattern may include a unique identifier enabling the processing unit to unambiguously associate detected features with their corresponding surface on the calibration fixture.

In certain embodiments, the one or more calibration parameters comprise intrinsic parameters and extrinsic parameters, and the processing unit is configured to determine the intrinsic parameters and the extrinsic parameters within a single unified optimization that jointly estimates both parameter types using the sensor data and the pose data acquired across the plurality of distinct poses. In some implementations, the processing unit executes instructions stored in a non-transitory memory to jointly estimate intrinsic parameters, extrinsic parameters, and kinematic chain parameters within a factor-graph optimization. In the factor-graph optimization, variable nodes represent at least the intrinsic parameters, the extrinsic parameters, and kinematic parameters of a kinematic model relating the movement device to the one or more sensors, and factor nodes encode constraints derived from at least visual reprojection residuals and kinematic chain consistency residuals. The jointly estimated parameters are output and applied as the one or more calibration parameters. In embodiments where the one or more sensors further comprise at least one inertial measurement unit, the factor-graph optimization may further comprise IMU preintegration factor nodes encoding constraints derived from inertial measurements acquired during transitions between the plurality of distinct poses, and the variable nodes may further represent an IMU bias vector and a spatial transformation between the inertial measurement unit and a reference frame fixed to the component.

In certain embodiments, the calibration system further comprises a compliance sensor interposed between the movement device and the component. The compliance sensor is configured to measure forces and torques exerted on the component during the effecting of relative positioning. The processing unit is further configured to detect, based on measurements from the compliance sensor, whether the component has been subjected to a force or torque exceeding a predefined threshold during any of the plurality of distinct poses, and to exclude sensor data and pose data associated with any pose at which the predefined threshold was exceeded from the determination of the one or more calibration parameters. In certain embodiments, the movement device comprises an articulated arm having at least six degrees of freedom. The controller is further configured to execute a first sweep of poses drawn from a coarse grid spanning a workspace of the movement device to acquire an initial set of sensor data and pose data, and to compute, based on the initial set of sensor data and pose data, an information-gain map identifying regions of the workspace in which additional poses would most reduce uncertainty in the one or more calibration parameters. The controller then executes a second sweep of poses concentrated in the identified regions to acquire a supplemental set of sensor data and pose data. The processing unit determines the one or more calibration parameters using the sensor data and pose data from both the first sweep and the second sweep.

In certain embodiments, prior to the determining, a machine-learning model trained on calibration data from a plurality of previously calibrated components is applied to predict initial values of at least a subset of the one or more calibration parameters, and the determining uses the predicted initial values as a starting point for an iterative optimization. Additionally or alternatively, the plurality of distinct poses may be selected by evaluating, for a set of candidate poses, an observability metric derived from a Fisher information matrix computed over the one or more calibration parameters. The plurality of distinct poses are selected to optimize the observability metric subject to at least one constraint selected from: joint limits of the movement device, collision avoidance between the component and the calibration fixture, or minimum feature visibility for each of the one or more sensors. In certain embodiments, prior to the removably securing, a calibration algorithm used in the determining is validated by instantiating virtual representations of the calibration fixture, the component, and the one or more sensors in a rendering engine, where the virtual representations are configured with known ground-truth calibration parameters and sensor noise models. Synthetic sensor data and synthetic pose data are generated by simulating the plurality of distinct poses in a simulated environment. The calibration algorithm is then executed on the synthetic sensor data and synthetic pose data to produce estimated calibration parameters, and the estimated calibration parameters are compared against the known ground-truth calibration parameters to verify that estimation errors fall below acceptance criteria.

In certain embodiments, after the determining, relative positioning between the component and the calibration fixture is effected at one or more validation poses distinct from the plurality of distinct poses used during determination of the one or more calibration parameters. A validation metric is computed from sensor data acquired at the one or more validation poses using the determined one or more calibration parameters, and the determined one or more calibration parameters are accepted or rejected based on whether the validation metric satisfies an acceptance criterion. In certain embodiments, during the effecting of relative positioning, a thermal state of the one or more sensors is monitored by reading one or more temperature sensors disposed on or proximate to the component. A temperature reading is associated with each of the plurality of distinct poses. The determining further comprises incorporating the temperature readings into the determination of the one or more calibration parameters by modeling at least one of the intrinsic parameters as a function of temperature, such that the one or more calibration parameters include temperature-dependent correction terms enabling compensation of thermally induced calibration drift during subsequent operation of the robot.

### BRIEF DESCRIPTION OF THE DRAWINGS

The accompanying drawing figures depict one or more implementations in accordance with the present teachings, by way of example only, and not by way of limitation. These figures are intended to illustrate and not to restrict the scope of the disclosure. In the figures, like reference numerals refer to the same or similar elements. This convention is maintained throughout the drawings for consistency and clarity.

FIG. 1 is a perspective view of a humanoid robot;

FIG. 2 is a diagram illustrating an example robot camera calibration system for the humanoid robot of FIG. 1;

FIGS. 3A-3C are perspective views of a camera calibration system for calibrating head-mounted cameras of the humanoid robot of FIG. 1; and

FIG. 4 is a flowchart showing a camera calibration process for calibrating cameras contained in the head of the humanoid robot, wherein said process may utilize the calibration system shown in FIG. 2.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high level, without extensive detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts, and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not include that particular feature, structure, or characteristic. Moreover, such phrases are not necessarily referring to the same embodiment. Further, when a particular feature, structure, or characteristic is described in connection with an embodiment, it is submitted that it is within the knowledge of one of skill in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be universally applied. Rather, in some embodiments, such features may be arranged in a different manner and/or order than shown in the illustrative figures. Additionally, the inclusion of a structural or method feature in a particular figure is not meant to imply that such a feature is present in all embodiments and, in some embodiments, may not be included or may be combined with other features.

### A. Introduction

Humanoid robots intended for real-world deployment rely on arrays of cameras mounted within the robot head to achieve spatial awareness and enable interaction with their environments. A typical humanoid robot head incorporates four or more camera groups—for example, eye cameras, chin cameras, top cameras, and rear cameras—collectively spanning a hemispherical field of regard encompassing ±180 degrees of azimuth and ±90 degrees of elevation. Accurate calibration of these cameras—encompassing intrinsic parameters (focal length, principal point, and lens distortion coefficients), extrinsic parameters (the six-degree-of-freedom rigid-body transformation between each camera and a common head reference frame), and kinematic parameters (the geometric relationships within the articulated mechanism that positions the head)—is a prerequisite for virtually all downstream perception tasks, including stereo depth estimation, panoramic image stitching, visual servoing, and cross-camera object tracking.

Despite steady growth in academic publications on robotic sensor calibration, no commercially viable, production-scale solution has emerged for calibrating multiple cameras oriented in different directions on a humanoid robot head. Multiple well-funded humanoid robotics programs—including efforts by major technology companies and government-funded research initiatives—have identified calibration as a technical obstacle limiting field deployment. Engineering teams at these organizations have consistently reported that calibration of multi-directional camera arrays required several hours of skilled technician time per unit, imposing labor cost and throughput constraints that rendered large-scale humanoid robot production economically infeasible. This long-felt, industry-wide need for an automated, production-scale calibration system for humanoid robot heads has persisted for over a decade without an adequate solution.

The persistent nature of this unmet need is not attributable to a lack of effort. Numerous prior approaches have been attempted and have failed to provide a satisfactory solution. The most widely practiced prior art approach involves an operator manually positioning a single planar calibration board in front of the robot head. This approach has been attempted by virtually every humanoid robotics program and has consistently failed to achieve the accuracy, repeatability, and throughput requirements of production environments. The approach introduces irreducible variability due to operator hand tremor, inconsistent board orientation, and the inability to simultaneously present calibration targets to camera groups facing different directions.

Some prior efforts addressed the multi-directional camera challenge by calibrating each camera group independently—for example, first calibrating the eye cameras with a forward-facing board, then physically rotating the robot or repositioning the board for the chin cameras, then for the top cameras, and so forth. This sequential approach failed because it could not establish a common reference frame across all camera groups in a single optimization. Instead, each group's calibration existed in its own coordinate frame, and the inter-group extrinsic parameters had to be estimated in a separate step that inherited and amplified the errors of each individual calibration. This approach consistently showed large enough to cause visible misalignment in stereo depth estimation and panoramic image stitching. The error amplification arises because the sequential approach involves a chain of independently estimated transformations (camera-to-board, board-to-movement-device, movement-device-to-head, and head-to-second-camera-group), and the total error grows as VN with the number N of independently estimated transformations.

Beyond the individual shortcomings of each prior approach, all prior art systems share a further fundamental limitation: the absence of a unified geometric framework that treats the physical calibration environment, the sensor array, and the kinematic positioning mechanism as a single coupled system subject to simultaneous optimization. Prior approaches decompose the calibration problem into a sequence of independent subproblems—intrinsic calibration of individual cameras using planar homography methods, followed by separate pairwise stereo extrinsic calibration, followed by independent kinematic identification of the positioning mechanism—each solved in isolation and each producing parameter estimates contaminated by errors inherited from preceding stages. This serial decomposition propagates and amplifies errors across stages because each subsequent stage takes the residual inaccuracies of the prior stages as fixed inputs rather than jointly optimizable unknowns. The repeated failure of these prior approaches engendered significant skepticism within the robotics industry regarding the feasibility of automated, production-scale multi-camera calibration for humanoid robot heads. Technical leaders at prominent humanoid robotics companies publicly stated at industry conferences that fully automated calibration of multi-directional head-mounted camera arrays was impractical for production and that some degree of manual intervention would always be necessary.

The present invention overcomes these deficiencies of the prior art by providing an integrated calibration system, apparatus, and method specifically designed for the automated calibration of multiple cameras contained within a humanoid robot head. At the core of the invention is a specialized calibration rig comprising a plurality of planar calibration surfaces arranged in an enclosing geometry, including surfaces positioned at precise angular relationships to one another (e.g., 90-degree and 135-degree orientations), such that distinct calibration patterns of known geometry are simultaneously visible to camera groups facing in different directions from any position within the rig. The calibration surfaces bear patterns selected from high-visibility chessboard patterns, complex geometric shapes, and high-contrast fiducial markers. The system further integrates a motorized positioning mechanism capable of autonomously maneuvering the humanoid robot head through a predefined sequence of spatial orientations relative to the calibration rig, thereby ensuring repeatable data collection without operator intervention. A multi-sensor acquisition module, coupled with a dedicated processing unit, continuously captures multi-angle visual and depth data as the positioning mechanism moves the robot head through its programmed orientations.

The processing unit executes a calibration algorithm that formulates the calibration as a holistic optimization in which all parameter types—intrinsic, extrinsic, and kinematic—are treated as interdependent variables within a single estimation framework. The algorithm applies computer vision techniques including edge detection, corner refinement, and outlier rejection to extract geometric features from the calibration patterns, and refines the robot's kinematic model by constructing a Jacobian matrix that treats each kinematic as a discrete, adjustable variable within the kinematic chain. By jointly optimizing all parameters to minimize the discrepancy between predicted and observed image-space projections, the system eliminates the error propagation inherent in sequential calibration approaches and achieves sub-pixel calibration accuracy across all camera groups. The known geometry of the calibration fixture's patterns anchors the reconstruction to an absolute metric scale, thereby eliminating the gauge freedom that renders software-only structure-from-motion methods inadequate for primary calibration. An integrated self-diagnostic module ensures long-term calibration reliability by continuously monitoring operational performance and employing statistical analysis of positioning errors to autonomously trigger recalibration protocols when performance degrades beyond predefined thresholds.

The disclosed system achieves, for the first time, sub-pixel calibration accuracy across all camera groups of a humanoid robot head in an automated, repeatable process with calibration cycle times compatible with production throughput requirements—for example, less than fifteen minutes per unit, compared to two to four hours per unit for manual approaches. The improvement in inter-group extrinsic rotation error represents a factor of 10 to 100 improvement over the prior art, which is particularly significant for applications that depend on consistent spatial registration across camera groups, such as panoramic three-dimensional reconstruction and cross-camera object tracking. The unexpectedly large improvement in both accuracy and throughput achieved by the present system—using a combination of component techniques (multi-planar targets, robotic arm positioning, Jacobian-based kinematic identification, and joint factor-graph optimization) that the industry's leading practitioners had access to individually but had not combined in the disclosed manner-further evidences the non-obvious nature of the present invention.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that the medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

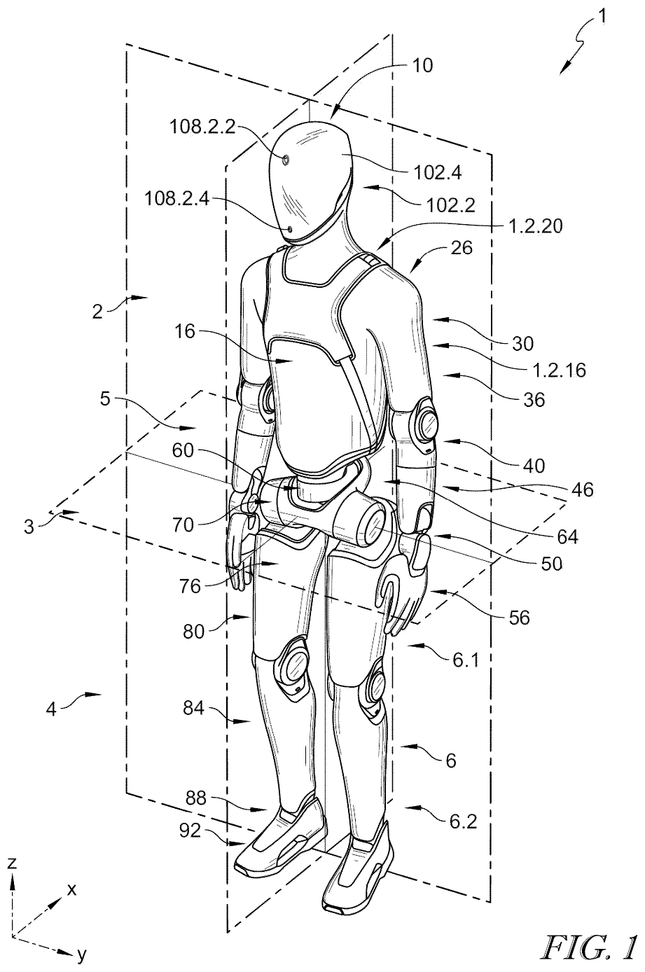

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 1.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (Ps) (e.g., as illustrated in FIG. 1) is a vertical plane positioned at a midway point between the left and right legs and the left and right arms and contains a rotational axis A₁₀ of a torso twist actuator (J10) (e.g., as illustrated in FIG. 1) located in the spine 60 of the robot 1 and divides the left and right sides of the robot 1 (e.g., as illustrated in FIG. 1). In other words, in an illustrative embodiment, the sagittal plane (Ps) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, the axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIG. 1), the coronal plane (Pc) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (PT) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 1, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 1 illustrates example Z, Y, X reference axes where the sagittal, coronal, and transverse planes share a common origin point.

Kinematic Chain: a representation of an assembly of rigid bodies connected by joints to provide constrained motion. Within this application, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bn): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Humanoid Robot

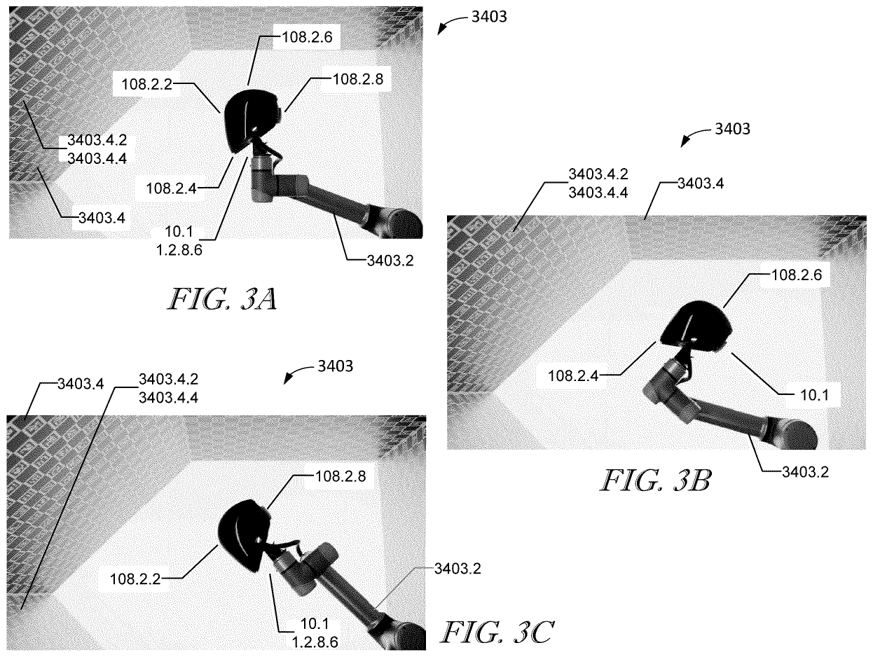

The humanoid robot 1 in the illustrative embodiment shown in FIG. 1 may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6. In the illustrative embodiment shown in FIG. 1, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

a. Head and Neck Assembly

The head and neck assembly 10 of the humanoid robot 1 is designed to enhance the robot's anthropomorphic characteristics while providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top. Structurally, the head 10.1 is symmetrical about the sagittal plane PS but is asymmetrical about Z-Y and X-Y planes that intersect the head and are parallel to the coronal plane (PC) and the transverse plane (PT), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself houses a range of components, such as high-resolution cameras, microphones, displays, gyroscopes, accelerometers, heat management systems (e.g., heat pipes, fans, etc.), wireless communication modules (e.g., 5G cellular, Wi-Fi, Bluetooth), and antennas, all of which are contained within an impact-resistant polymer shell 102.2. The head and neck assembly 10 may also incorporate advanced materials and shock-absorbing structures to protect the sensitive electronic components housed within, which improves the overall durability and reliability of the humanoid robot 1. The shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Among the components housed within the head 10.1 are multiple sensors to enable environmental perception and interaction. These sensors include visual sensors such as high-resolution cameras, dynamic iris control, and eye-tracking software for lifelike gaze behavior; auditory sensors such as microphones and bone conduction audio systems for enhanced sound detection and speech processing; tactile sensors such as pressure-sensitive elements embedded in facial surfaces for interaction sensing; and biometric authentication systems incorporating facial recognition and voice analysis. A modular sensory array is implemented, allowing interchangeable sensor modules such as thermal imaging cameras or specialized environmental detectors for various applications. The sensor modules communicate over a standardized digital bus (e.g., a high-speed serial interface such as MIPI CSI-2, USB 3.x, or a custom LVDS link) to a central sensor hub located within the head 10.1, facilitating plug-and-play integration of new sensor types. The central sensor hub includes a multiplexer that routes sensor data streams to the appropriate processing pipeline and a timestamp insertion module that tags each data frame with a monotonically increasing, common-clock timestamp for temporal synchronization.

Most notably, the visual perception system comprises a systematically distributed array of high-resolution cameras to provide overlapping and complete spatial awareness. This extensive visual suite features dynamic iris control and eye-tracking capabilities, specifically structured around dedicated camera groupings such as eye cameras 108.2.2, chin-mounted cameras 108.2.4, top-mounted cameras 108.2.6, and rear-facing back cameras 108.2.8. Each camera grouping is oriented to cover a distinct angular sector of the surrounding environment, and the overlapping fields of view between adjacent groupings facilitate stereo depth estimation and seamless panoramic reconstruction. Each camera has a resolution of at least 1920×1080 pixels (Full HD), or in higher-end configurations 4096×2160 pixels (4K), and operates at a frame rate of at least 30 frames per second with a global shutter or a rolling shutter with a readout time of less than 10 milliseconds. The cameras employ CMOS image sensors with a pixel pitch in the range of 1.0 to 3.0 micrometers, a quantum efficiency of at least 50% at 550 nm, and a signal-to-noise ratio of at least 40 dB at full-well capacity. The lens assembly for each camera has a focal length in the range of 2.0 to 12.0 millimeters, selected to provide the desired field of view for each camera group's coverage sector (e.g., 80-120 degrees horizontal field of view for the eye cameras, 60-90 degrees for the chin cameras). The lens may be a fixed-focus lens with the focus set at a hyperfocal distance appropriate for the robot's operating range (e.g., 0.3 meters to infinity), or an autofocus lens that is locked to a fixed focus position during calibration to prevent focus-induced intrinsic parameter variation. The cameras embedded within the head 10.1 include RGB, depth-sensing, and thermal imaging capabilities. For the specific purpose of generating a low-latency Virtual Reality (VR) view, a pair of high-resolution, high-frame-rate RGB cameras with global shutters may be utilized; for example, this pair of cameras may be the vertically arranged cameras 108.2.2 and 108.2.4, or they may be horizontally arranged internal/external cameras.

In some implementations, depth cameras are incorporated alongside the standard RGB cameras to significantly enhance the calibration system's capabilities. Depth information facilitates 3D reconstruction of chessboard corners, augmenting the calibration process with additional data points. This depth-aware approach is particularly beneficial in scenarios where conventional 2D image-based methods may be insufficient, such as when the calibration target occupies a narrow angular extent in the image or when perspective distortion reduces the effective resolution of corner detection. The depth cameras may employ time-of-flight (ToF) sensing with a depth measurement range of 0.1 to 10.0 meters and a depth resolution of less than 5 millimeters at a range of 1.0 meter, or structured-light sensing with comparable performance characteristics. The microphones, in turn, are arranged in an array to facilitate directional audio input and noise cancellation, which enhances the ability of the humanoid robot 1 to understand and respond to verbal commands. In addition to conventional microphone arrays, bone conduction audio systems provide enhanced sound detection and speech processing capabilities.

Displays integrated into the head 10.1 serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1. Complementing the displays, an extent of the illumination assembly 1.2.10, which comprises a plurality of light emitters, is positioned adjacent to an edge (e.g., lower) of the frontal shield 102.4. These light emitters are configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than the displays and may relay information more rapidly. To maximize bandwidth and ensure connectivity for communication, a plurality of 5G cellular radios may be positioned in the torso 16 and wired through the neck to the antennas in the head 10.1.

To further improve human-robot interaction, the head 10.1 incorporates gaze-driven attention systems to prioritize visual processing, haptic feedback networks with micro-vibration actuators to simulate tactile sensations, subtle behavioral cues such as head tilts, simulated breathing, or micro-movements to mimic natural human engagement, and holographic projection systems for three-dimensional data visualization and enhanced communication. The integration of augmented reality display technology within the eyes or face of the robot further enhances communication by overlaying digital information onto real-world visuals, improving situational awareness and interaction efficiency. In some embodiments, the gaze-driven attention system receives calibrated camera pose information to direct the robot's visual focus toward a target of interest, with the accuracy of this directed attention being directly dependent on the quality of the extrinsic calibration among the eye cameras 108.2.2 and the head's pan-tilt actuation chain. The haptic feedback networks may additionally be used during the calibration validation phase to provide a tactile indication to an operator when a calibration target has been detected within a camera's field of view.

The head and neck assembly 10 includes two primary actuators that enable the head movements on which many of the foregoing sensory and interaction capabilities depend: a head twist actuator (J8.1) 120, which is responsible for enabling rotational movement of the head 10.1 about axis A8.1, which is a vertical (yaw) axis when the robot is in the neutral state, and a head nod actuator (J8.2) 140, which enables rotation of the head 10.1 about the axis A8.2, which is a horizontal axis when the robot is in the neutral state. Together, these two actuators provide two degrees of freedom for the head 10.1, allowing it to perform movements that emulate natural human head motions. The head twist actuator (J8.1) 120 is positioned within the head and neck assembly 10, while the head nod actuator (J8.2) 140 is located at the base of the neck. The head twist actuator (J8.1) 120 and the head nod actuator (J8.2) 140 each utilize a motor, a gear reduction system, and sensors or encoders that are similar to the actuator types discussed herein. The head actuators, J8.1 and J8.2, work in coordination to position the head 10.1 accurately, enabling the humanoid robot 1 to track objects, focus on specific areas of interest, or maintain eye contact during human-robot interactions. The actuators are controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle. Variations of this design include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms. Advanced control algorithms are implemented to enable more natural, biomimetic head movements, potentially incorporating machine learning techniques to adapt and refine the motion patterns of the head 10.1 based on interaction data and environmental feedback.

The design of the humanoid robot head 10.1 supports future upgrades through standardized modular interfaces for sensors and actuation systems, reconfigurable skull structures with adjustable segments for varying head shapes and sizes, and software-defined hardware that enables functionality expansion through firmware updates rather than physical modifications. These standardized interfaces define mechanical mounting patterns, electrical connector pinouts, and communication protocols that allow a sensor module designed for one generation of the head 10.1 to be installed on a subsequent generation without modification. Modular head designs allow for the quick customization or replacement of sensory and communication components, facilitating easy upgrades or modifications to the capabilities of the humanoid robot 1 without requiring extensive changes to the overall head and neck assembly 10. The incorporation of an adaptive metamaterial skin enables the robot to dynamically change surface properties such as texture, thermal conductivity, or even coloration, further enhancing realism and adaptability. The head 10.1 additionally possesses the ability to self-diagnose and perform minor self-repairs through embedded micro-actuators and diagnostic circuits, enhancing longevity and reliability and ensuring consistent performance across extended operational periods. By integrating advanced materials, sensor technologies, computational capabilities, and human-like expressiveness, the humanoid robot head and neck assembly 10 serves as a sophisticated interface for interaction, perception, and cognitive processing. Its modular and scalable design ensures adaptability for diverse applications, from social robotics to industrial automation.

b. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

c. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

d. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

### D. Calibration System Setup

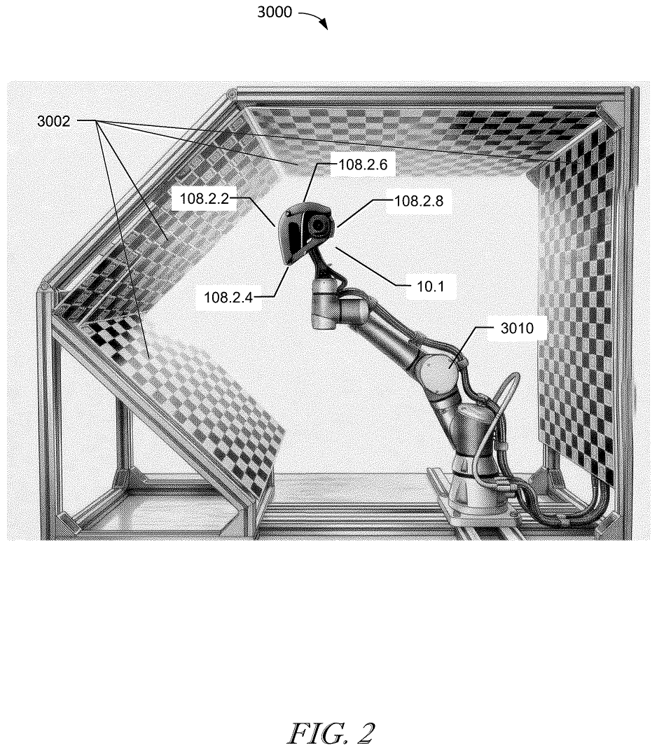

As illustrated in FIG. 2, the accuracy of the visual perception and gaze-driven attention systems is maintained through a calibration system that integrates advanced hardware and software components to ensure precise positioning and sensing capabilities. To implement these advanced calibration methodologies, the calibration system utilizes a highly specialized calibration rig 3000, designed specifically to accommodate the unique physical and sensory architecture of the humanoid robot head 10.1. Within this setup, the robot head 10.1, which serves as the primary subject of calibration, is securely mounted onto a dedicated robot arm fixture 3010. This robot arm fixture 3010 operates strictly as a structural and manipulative component of the calibration rig 3000 itself—rather than acting as a constituent part of the final humanoid robot 1—providing precise, repeatable articulation through various spatial orientations during the calibration sequence. The robot arm fixture 3010 may be a six-axis or seven-axis industrial robotic manipulator with a repeatability specification of less than 0.1 millimeters (e.g., ±0.02 mm at the tool center point (TCP) under ISO 9283 test conditions), ensuring that the positional uncertainty introduced by the fixture itself remains negligible relative to the calibration accuracy targets.

The robot arm fixture 3010 (or movement device 3403.2) terminates in a specialized end-effector designed to securely and repeatably grip the humanoid robot head 10.1 without contacting, obscuring, or mechanically loading any of the sensor elements to be calibrated. In one embodiment, the end-effector comprises a cradle structure that contacts the head at predefined non-sensor regions-such as the base of the skull framework, the rear structural shell, or dedicated mounting flanges integrated into the head's structural design during manufacturing. The cradle incorporates kinematic coupling features (such as three-point ball-and-groove contacts, Maxwell-style kinematic mounts, or precision dowel pins engaging corresponding holes in the head structure) that constrain the head's position and orientation relative to the end-effector with sub-millimeter repeatability (e.g., less than 0.05 mm translational and less than 0.01 degree rotational repeatability). This kinematic coupling ensures that the spatial relationship between the end-effector's TCP and the head's internal coordinate frame is known and consistent across calibration sessions, enabling the system to use the robotic arm's joint encoder readings to compute an independent estimate of the head's pose that can be compared against the vision-based pose estimate during calibration.

The kinematic coupling design follows the principle of exact constraint: three non-collinear contact points, each constraining two translational degrees of freedom, together constrain all six rigid-body degrees of freedom of the head relative to the end-effector, with no over-constraint that could cause indeterminate contact forces or thermally-induced stress. In an alternative embodiment, the kinematic coupling may comprise a three-groove-three-ball (Kelvin clamp) configuration or a three-V-groove-three-ball (Maxwell clamp) configuration, each providing deterministic, repeatable positioning. The contact surfaces may be hardened steel or ceramic to minimize wear-induced positioning drift over thousands of engage/disengage cycles. Each coupling contact point may be preloaded by a magnet, a spring, or a pneumatic clamp to ensure positive contact and prevent separation under the inertial loads experienced during the calibration pose sequence.

In some implementations, the end-effector includes a quick-release mechanism that allows an operator to load and unload the humanoid head in less than a predefined time (e.g., less than 30 seconds), facilitating high-throughput production calibration where multiple heads are calibrated in sequence. The quick-release mechanism may be pneumatically actuated, magnetically latched, or spring-loaded, and may include a sensor (such as a proximity switch, force sensor, or optical break-beam) that confirms proper seating of the head before the calibration sequence commences. If the seating sensor indicates improper engagement (e.g., one or more coupling contact points not fully seated), the controller refuses to begin the calibration sequence and alerts the operator via the graphical user interface. The end-effector may also include electrical and data connectors that automatically engage when the head is seated, providing power to the head's cameras, sensors, and processing electronics, and establishing a data link for real-time image and sensor data transfer to the calibration processing unit. These connectors may be spring-loaded pogo-pin arrays or magnetic connectors that self-align upon engagement, providing reliable electrical contact without requiring precise manual alignment by the operator.

The robot head 10.1 houses a comprehensive suite of visual sensors, systematically distributed to provide overlapping and complete spatial awareness, which can include eye cameras 108.2.2, chin-mounted cameras 108.2.4, top-mounted cameras 108.2.6, and rear-facing back cameras 108.2.8. To correspond with this expansive sensor array, the calibration rig 3000 features a precisely arranged enclosure of surrounding panels 3002, each adorned with high-contrast calibration markers such as chessboard patterns. These surrounding panels 3002 are strategically positioned in distinct spatial zones-specifically covering the front bottom, front top, overhead top, and back areas-so that they directly align with the respective fields of view for the four distinct groups of cameras 108.2.2, 108.2.4, 108.2.6, and 108.2.8. In one embodiment, the surrounding panels 3002 are fabricated from rigid, dimensionally stable substrate materials such as optical-grade glass, machined aluminum, or ceramic composites, onto which the calibration markers are printed or etched with sub-millimeter placement tolerance (e.g., +0.05 mm feature placement accuracy verified by coordinate measuring machine inspection).

A core aspect of the calibration process is the camera calibration procedure, employing the chessboard pattern on the surrounding panels 3002 as a reference object. By capturing multiple images from diverse angles and distances—achieved through the robot arm fixture 3010 articulating the head 10.1 through a sequence of spatial orientations—the system establishes ground truth data based on the known dimensions and geometry of the chessboard. The ground truth encompasses the physical spacing between adjacent corners (e.g., a corner spacing of 20.0 mm±0.05 mm), the planarity of the board surface (e.g., a surface flatness of less than 0.1 mm over the board area), and the total number of internal corners in each row and column (e.g., a 9×6 grid of internal corners). This enables the precise computation of intrinsic camera parameters, including focal length, principal point, and lens distortion coefficients. Advanced computer vision algorithms are employed to detect and extract chessboard corners from the collected images. These algorithms include edge detection, corner refinement, and outlier rejection techniques to ensure accurate and consistent corner localization. Depending on computational demands, these processes may be executed on the robot's onboard processing unit for real-time calibration or on an external computer for more complex operations. The calibration system thereby utilizes sophisticated methodologies to enhance accuracy, reliability, and adaptability across various applications.

a. Angular Geometry of the Calibration Enclosure

The calibration rig 3000 (or calibration fixture 3403.4) may comprise a plurality of planar surfaces arranged at specific angular relationships selected to optimize the geometric diversity of calibration observations across all camera groups on the humanoid robot head 10.1. In one embodiment, at least two planar surfaces are positioned at approximately 90 degrees relative to each other, and at least two additional planar surfaces are positioned at approximately 135 degrees relative to each other. The selection of these specific angular values is technically motivated by the need to maximize the observability of all calibration parameters—both intrinsic camera parameters and extrinsic spatial relationships—while simultaneously providing coverage to camera groups oriented in different directions.

The 90-degree angular arrangement between adjacent planar surfaces provides maximum geometric diversity for cameras viewing the intersection region between those surfaces. When a camera observes calibration pattern features on two surfaces meeting at 90 degrees, the resulting observation geometry spans a wide angular range relative to the camera's optical axis, which improves the numerical conditioning of the intrinsic parameter estimation (particularly the estimation of focal length and principal point, which are poorly constrained when all observations lie on a single plane viewed at near-normal incidence). Quantitatively, the condition number of the normal equations matrix for the intrinsic parameter estimation may be reduced by a factor of 5 to 50 when observations from two orthogonal surfaces are included compared to observations from a single surface, depending on the camera's field of view and the number of observation poses. The 90-degree arrangement also provides strong constraints for depth estimation, as the intersection line between the two surfaces creates a geometric discontinuity that depth cameras can resolve with high confidence, anchoring the 3D reconstruction of the calibration environment.

The 135-degree angular arrangement between other pairs of planar surfaces serves a complementary function. Surfaces meeting at 135 degrees present a shallower angular transition that is particularly beneficial for cameras viewing the calibration rig at oblique angles-such as the chin-mounted cameras 108.2.4 viewing front-top panels or the top-mounted cameras 108.2.6 viewing overhead panels. At these oblique viewing geometries, a 90-degree surface intersection may cause one of the two surfaces to be viewed at such a steep grazing angle (e.g., less than 15 degrees from the surface plane) that calibration pattern features on that surface cannot be reliably detected due to extreme foreshortening and perspective distortion. The 135-degree arrangement mitigates this problem by keeping both surfaces within a detectable angular range (e.g., at least 22.5 degrees from the surface plane for a camera viewing the intersection at the bisector angle) even at oblique viewpoints, ensuring that multiple surfaces contribute calibration observations to every camera group at every pose in the calibration sequence.

In some implementations, the angular arrangement of the planar surfaces may be determined through a simulation-based optimization procedure. This procedure may model the fields of view of all camera groups on the humanoid robot head, simulate the observation geometry at each pose in a candidate calibration sequence, compute an observability metric (such as the condition number or minimum singular value of an information matrix for the full parameter vector), and iteratively adjust the panel angles to maximize this metric. The 90-degree and 135-degree values disclosed herein may represent the result of such an optimization for a specific humanoid head geometry, and other angular values (such as 60 degrees, 100 degrees, 120 degrees, or 150 degrees) may be optimal for different head geometries, camera placements, or calibration sequence designs. The calibration rig may incorporate adjustable hinges, slotted mounting brackets, or other angular adjustment mechanisms that allow the panel angles to be reconfigured for different robot head variants without the fabrication of a new rig.

b. Zone-Specific Panel Placement and Camera Group Correspondence

The surrounding panels 3002 of the calibration rig 3000 are not uniformly distributed around the robot head 10.1 but are instead strategically positioned in distinct spatial zones that correspond to the fields of view of the respective camera groups. Specifically, front-bottom panels are positioned to fall within the primary field of view of the eye cameras 108.2.2; front-top panels are positioned to fall within the primary field of view of the chin-mounted cameras 108.2.4; overhead panels are positioned to fall within the primary field of view of the top-mounted cameras 108.2.6; and rear panels are positioned to fall within the primary field of view of the rear-facing back cameras 108.2.8. This zone-specific arrangement ensures that at each pose in the calibration sequence, every camera group observes at least one dedicated panel bearing calibration pattern features with sufficient spatial resolution and angular diversity to contribute meaningful constraints to the calibration optimization.

In one embodiment, each spatial zone may contain two or more panels meeting at different angles (e.g., one pair at 90 degrees and another pair at 135 degrees within the same zone), such that even a single camera group receives observations from surfaces at multiple angular orientations within its own field of view, further improving the conditioning of the per-group intrinsic and extrinsic parameter estimation. The panels within each zone may bear distinct calibration patterns (e.g., different hybrid chessboard-fiducial board configurations with unique marker identifiers) to enable unambiguous identification of which panel is being observed by which camera, even when fields of view overlap between adjacent camera groups. This unambiguous identification is central for the joint optimization to correctly associate observed features with their known 3D locations on the calibration rig. Specifically, each hybrid board may embed a set of fiducial markers (e.g., 6×6 binary-encoded markers from a dictionary of at least 250 unique identifiers) within the chessboard grid, and each marker's decoded identifier maps to a unique panel index and a unique subset of corner coordinates within the rig's global coordinate frame. This allows the feature detection pipeline to immediately determine, upon detecting any single fiducial marker, both (a) which panel is being observed and (b) the global 3D coordinates of all chessboard corners adjacent to that marker, without requiring the complete board to be visible.

The spatial zones may also be designed such that certain panels are simultaneously visible to two or more camera groups at specific poses in the calibration sequence. These overlapping observations provide direct constraints on the relative extrinsic parameters between camera groups, enabling the optimization to estimate inter-group spatial relationships with higher accuracy than would be achievable from per-group observations alone. The calibration sequence may be designed to include a minimum number of such overlapping-observation poses for each pair of adjacent camera groups, ensuring that all pairwise extrinsic relationships are well-constrained. The requirement for at least three overlapping observations per camera pair is motivated by the fact that each overlapping observation provides six constraint equations (three translational, three rotational), and the inter-group extrinsic transformation has six degrees of freedom; three observations provide 18 equations for 6 unknowns, yielding a three-fold overdetermination that provides robustness against measurement noise.

The reflective boards may have a matte or semi-matte surface finish to reduce specular reflections that could otherwise saturate camera pixels and degrade corner detection performance. In one embodiment, the surrounding panels 3002 may also be fabricated from dimensionally stable substrate materials resistant to warping under variations in temperature and humidity (e.g., a coefficient of thermal expansion of less than 5 ppm/° C. and a moisture expansion coefficient of less than 0.01%), thereby ensuring that the calibration pattern geometry remains within specification over the operational lifetime of the rig.

To optimize data collection, the calibration system may include a motorized positioning system such as the robotic arm fixture 3010, enabling the robot head to move through a predefined sequence of orientations. This automated mechanism ensures comprehensive image acquisition from multiple viewpoints, following optimized trajectories that maximize calibration coverage while minimizing the number of images to be captured. The predefined sequence of orientations may be computed offline using a trajectory planner that selects poses to provide adequate coverage and diversity of observation geometries for the intrinsic and extrinsic parameters to be estimated. The software architecture is modular and extensible, comprising dedicated modules for image processing, feature extraction, and mathematical optimization. These modules collaboratively refine calibration results, employing techniques such as bundle adjustment and non-linear least squares methods for iterative parameter optimization.

c. Calibration Pose Sequence Design

The predefined sequence of orientations through which the robot arm fixture 3010 moves the robot head 10.1 may be designed using any suitable pose selection strategy. In a first embodiment, the pose sequence may be determined using an observability-maximizing algorithm that operates by: (a) defining the full set of calibration parameters to be estimated (including intrinsic parameters for each camera, extrinsic parameters for each camera group relative to the head frame, kinematic chain parameters, and spatial offsets for auxiliary sensors such as IMUs and microphone arrays); (b) for a candidate set of poses, computing an information matrix (such as a Fisher information matrix) for the full parameter vector based on the predicted observation geometry at each pose; (c) evaluating the information matrix using metrics such as the D-optimality criterion (maximizing the determinant), the A-optimality criterion (minimizing the trace of the inverse), or the E-optimality criterion (maximizing the minimum eigenvalue); and (d) iteratively adding, removing, or adjusting poses to optimize the selected criterion subject to constraints such as joint limits of the robotic arm, collision avoidance between the head and the calibration rig panels, and minimum feature visibility considerations for each camera group.

In a second embodiment, the pose sequence may comprise a fixed, predetermined set of poses that are defined during the initial design and commissioning of the calibration rig and are not adapted or optimized on a per-unit basis. This fixed pose sequence may be determined empirically during a commissioning phase in which a set of candidate poses is evaluated using a representative sample of humanoid robot heads (e.g., 10 to 20 pilot units), and the subset of poses that consistently yields calibration results meeting acceptance criteria is selected and stored as the production pose sequence. The fixed pose sequence may be designed to include poses that uniformly sample the workspace of the robot arm fixture 3010 within the volume defined by the calibration enclosure, ensuring that each camera group observes its corresponding panels from a sufficient diversity of distances (e.g., near: 0.2-0.4 m, mid: 0.4-0.7 m, far: 0.7-1.0 m) and angles (e.g., ±20° pitch, ±30° yaw, ±10° roll relative to panel-normal) without invoking any per-unit optimization of the pose selection. This fixed-sequence embodiment provides the advantage of simplified system implementation—eliminating the need for a per-unit optimization step—and deterministic, predictable calibration throughput in high-volume production environments. In some implementations, the fixed pose sequence may be stored as an ordered list of joint-angle vectors (e.g., six floating-point values per pose, specifying the target angle for each of the six joints of the robot arm fixture) in a non-volatile memory of the calibration system controller, and the controller may execute the sequence identically for each unit presented for calibration.

In a third embodiment, the pose sequence may be designed using a hybrid approach in which a fixed base sequence of poses (determined empirically or analytically during system commissioning) is augmented with a small number of additional poses selected adaptively during the calibration of each individual unit. The adaptive augmentation may be triggered when the processing unit detects, during the execution of the base sequence, that one or more camera groups have received insufficient observation diversity—for example, because a camera's images at certain base poses were corrupted by transient lighting artifacts, or because the feature detector failed to localize a sufficient number of corners at a particular pose (e.g., fewer than 20 corners detected out of the expected 54). In this hybrid embodiment, the adaptive augmentation adds only the minimum number of additional poses needed to satisfy a predefined observation diversity criterion for each camera group, thereby combining the throughput predictability of a fixed sequence with the robustness of adaptive optimization.

In one embodiment, the calibration pose sequence comprises between 20 and 100 distinct poses, with the specific number determined by the chosen pose selection strategy to achieve a target calibration uncertainty (e.g., sub-pixel reprojection error for all camera groups and sub-millimeter extrinsic parameter uncertainty). As a concrete example, a typical production calibration sequence may comprise 40 poses (10 per camera group zone, with each set of 10 spanning three distances and several orientations), with each pose requiring approximately 1 second for motion, 0.3 seconds for settling, and 0.2 seconds for image capture, yielding a data acquisition phase duration of approximately 60 seconds. The sequence may be ordered to minimize total travel time of the robotic arm between successive poses, following a trajectory optimization (e.g., a traveling-salesman-problem heuristic applied to the joint-space distances between poses) that respects the arm's velocity and acceleration limits while avoiding motion that could induce vibrations affecting image quality. At each pose, the system may wait for a predefined settling time (e.g., 100-500 milliseconds) after the arm reaches its commanded position before triggering image capture, to ensure that residual vibrations from the arm's deceleration have dissipated below a threshold level (e.g., less than 0.1 pixels of image motion as estimated from IMU readings or sequential image differencing).

The pose sequence may also include dedicated validation poses that are not used for calibration parameter estimation but are reserved for post-calibration accuracy assessment. At these validation poses, the system computes the reprojection error for each camera group using the estimated calibration parameters and compares the error against acceptance thresholds. If any camera group fails the validation check at these poses, the system may automatically augment the calibration sequence with additional poses in the angular region where the failure occurred and re-estimate the parameters using the augmented dataset.

The implementation of this enclosed, multi-panel calibration setting provides numerous substantial benefits for the accurate tuning of advanced robotic vision systems. By utilizing the dedicated robot arm fixture 3010 to manipulate the robot head 10.1, the system can execute highly controlled, automated sweeps through the predefined sequences of orientations, ensuring comprehensive visual coverage of the surrounding panels 3002 without relying on the robot's own potentially uncalibrated internal kinematic chains. This isolation of movement allows the calibration algorithms to establish highly reliable ground truth data, minimizing external noise and mechanical artifacts that might otherwise skew the parameter calculations. Furthermore, the strategic spatial correlation between the distinct camera groupings on the head and the correspondingly angled calibration panels facilitates simultaneous multi-camera calibration. This parallel data acquisition significantly expedites the calibration timeline while enabling the processing unit to precisely map the intricate interdependencies and overlapping fields of view among the eye, chin, top, and back cameras. Ultimately, this comprehensive, automated enclosure empowers the calibration system to generate a highly unified and precise three-dimensional perceptual model, enhancing the robot's depth estimation, spatial awareness, and overall environmental interaction capabilities in subsequent real-world deployments.

d. Projector-Based Calibration Patterns

In an alternative embodiment, the calibration fixture may comprise one or more projection surfaces onto which calibration patterns are dynamically projected by one or more digital projectors, rather than being physically printed or etched onto rigid panels. In this projector-based configuration, one or more structured-light projectors (such as digital light processing (DLP) projectors, laser projectors, or liquid crystal on silicon (LCOS) projectors) are rigidly mounted to the calibration rig frame and directed toward planar or curved projection surfaces positioned in the spatial zones corresponding to the camera groups' fields of view. The projection surfaces may be constructed from materials optimized for diffuse reflectivity—such as matte white laminate, micro-bead-coated retro-reflective screen material, or ambient-light-rejecting screen material—to ensure uniform brightness and minimal specular artifacts across the projected image area. The projectors may have a native resolution of at least 1920×1080 pixels, a contrast ratio of at least 1000:1, and a luminous output of at least 2000 lumens, ensuring that the projected calibration features are detectable by the robot head's cameras under the ambient lighting conditions within the calibration enclosure. The projector's refresh rate may be at least 60 Hz, and the projector may be synchronized to the camera trigger system via the same FPGA-based trigger generator used for the cameras, ensuring that projected pattern transitions occur only between camera exposures and that each camera exposure captures a stable, fully-rendered pattern.

The digital projectors generate calibration patterns dynamically under software control, enabling the calibration system to adapt the projected pattern in real time based on feedback from the calibration processing pipeline. For example, if the processing unit detects that a particular camera group has insufficient corner detections in a specific image region (due to lens vignetting, ambient light contamination, partial occlusion by rig structural elements, or unfavorable viewing geometry at the current pose), the projector corresponding to that camera group's zone may increase the density of calibration features in the undersampled region, switch to a higher-contrast pattern, display a larger pattern suitable for long-range detection, or display a different pattern type (e.g., switching from a chessboard grid to a circle grid, a randomized dot pattern, or an asymmetric fiducial marker array) that is better suited to the current observation conditions. This adaptive, closed-loop pattern generation may be governed by a pattern quality controller that, at each pose in the calibration sequence, evaluates the spatial distribution and detection confidence of extracted features across each camera group's image, computes a feature quality metric (e.g., the ratio of detected corners to expected corners, weighted by their spatial uniformity across the image) for each image region, and commands the projector to adjust its output before the next image capture.

The projector-based embodiment offers several advantages over static printed patterns. First, it eliminates the need to manufacture precision-printed calibration boards, reducing the material cost and lead time of the calibration rig and facilitating rapid reconfiguration for different robot head variants with different camera fields of view or different optimal pattern geometries. Second, it enables temporal coding strategies-such as projecting a sequence of complementary binary or Gray-coded stripe patterns in rapid succession—that can be decoded by the cameras to produce dense per-pixel correspondences between the camera image plane and the projection surface, providing far richer calibration data (up to one correspondence per pixel, compared to one correspondence per chessboard corner) than a static corner-based pattern. Third, it allows the system to project unique, temporally modulated identification codes on each projection surface, eliminating the need for spatially distinct marker patterns on different panels and simplifying the feature-to-panel association logic in the processing pipeline. Fourth, the projector may project patterns at calibrated intensities (e.g., a uniform gray gradient from 0% to 100% reflectance), enabling radiometric calibration (characterization of each camera's intensity response curve, including gamma, black level, and linearity) in addition to geometric calibration, within the same calibration session.

In a combined embodiment, the calibration rig may include both static printed panels in certain spatial zones and projector-illuminated surfaces in other zones. For instance, zones corresponding to camera groups with well-characterized fields of view and consistent viewing geometry may retain static printed panels for maximum dimensional stability and simplicity, while zones corresponding to camera groups with more variable viewing conditions may employ projector-based surfaces for adaptive pattern generation.

The known spatial geometry of the projection surfaces-including their position and orientation within the calibration rig's coordinate frame-serves as the ground truth reference, analogous to the known geometry of printed calibration boards. The projectors themselves need not be calibrated to high accuracy, because the calibration system uses the known geometry of the projection surfaces (which are rigid, dimensionally stable physical structures) rather than the projector's internal optical model as the geometric reference. However, in some implementations, the projector's optical model may be calibrated (using a procedure analogous to camera calibration, treating the projector as an “inverse camera”) to enable precise mapping between projected pixel coordinates and physical positions on the projection surface, further improving the density and accuracy of the projected calibration features.

e. Movable-Target Calibration Configuration

In another alternative embodiment, the calibration system may be configured such that the component under calibration (e.g., the humanoid robot head 10.1) remains stationary while the calibration fixture or target is mounted on a movement device that repositions the target through a plurality of poses relative to the stationary component. In this inverted-fixture configuration, the humanoid robot head 10.1 is secured to a stationary support structure 5010 (such as a rigid pedestal, a wall-mounted bracket, or a floor-standing frame) at a fixed, known position and orientation within the calibration environment. A movement device 5020—such as a multi-axis robotic arm, a gantry system, a turntable-and-linear-rail combination, or any other programmable positioning mechanism—carries one or more calibration targets 5030, each bearing a pattern of known geometry (such as a chessboard, a fiducial marker array, or a hybrid chessboard-fiducial board), and positions these targets at a plurality of distinct poses relative to the stationary head 10.1.

At each pose, the cameras and other sensors on the head 10.1 capture image and depth data of the calibration target 5030, and the movement device 5020 records its own configuration (e.g., joint encoder readings, linear stage positions, or turntable angle) as pose data indicative of the spatial relationship between the target and the stationary support structure. The processing unit receives the sensor data and the pose data and determines the calibration parameters of the sensors based on a comparison between the detected feature locations in the sensor data and the known feature locations on the calibration target, using the pose data from the movement device 5020 to relate the observations across the plurality of poses.

This movable-target configuration offers several practical advantages. First, it eliminates the need to physically handle, mount, and dismount the humanoid robot head on a robotic arm end-effector, reducing the risk of mechanical damage to the head's sensors and structural components and simplifying the operator workflow. Second, it allows the calibration system to accommodate robot heads that are already installed on their robot bodies: rather than disassembling the head from the body, the entire robot may be positioned in front of the stationary support structure, and the movable-target device may present calibration targets around the head. Third, in a multi-head production environment, a single movable-target system may service a conveyor or carousel of robot heads, sequentially presenting targets to each head without the head-loading and head-unloading steps required in the component-on-arm configuration.

In a further refinement of the movable-target configuration, the movement device 5020 may carry a plurality of calibration targets simultaneously—for example, one target directed toward the front of the head and another directed toward the rear- and may position these targets such that multiple camera groups on the head 10.1 can observe calibration features simultaneously, providing the same multi-group simultaneous observation benefit achieved by the multi-panel enclosure in the primary embodiment. In yet another refinement, the movable-target device 5020 may carry a single large calibration target that wraps around the head (e.g., a flexible panel or a curved screen), presenting calibration features to camera groups in multiple directions simultaneously from a single target. The target may also incorporate the projector-based pattern generation described above.

In some implementations, the movable-target configuration and the component-on-arm configuration may be combined within a single calibration rig. For example, the humanoid robot head 10.1 may be mounted on a robot arm fixture 3010 that provides coarse positioning within the calibration enclosure, while one or more auxiliary targets mounted on secondary movement devices 5020 are positioned to provide additional calibration observations from angles or distances not adequately covered by the stationary surrounding panels 3002. This combined configuration increases the total number of observation constraints available to the optimization, improving calibration accuracy and robustness.

f. Conveyor-Based Production Calibration Configuration

In a further alternative embodiment, the calibration system may be configured for high-throughput production environments using a conveyor-based material handling system. In this configuration, a conveyor belt, a roller conveyor, or an overhead gantry transport system transports humanoid robot heads (or other sensor-equipped components) through a calibration station at which the calibration rig 3000 is installed. Each head is presented to the calibration station on a standardized carrier pallet 6010 that includes locating features (such as precision dowel pins, V-groove rails, or kinematic coupling elements) that position the head at a known orientation and height relative to the carrier pallet's reference frame. As the carrier pallet enters the calibration station, a registration mechanism (such as a mechanical stop, a pneumatic clamping system, or a vision-guided alignment system) engages the pallet and constrains it at a known position within the calibration rig's coordinate frame.

In a first variant of the conveyor-based configuration, the carrier pallet remains stationary at the registration position while a movement device (such as a robot arm fixture 3010 or a multi-axis gantry) picks up the head from the pallet, executes the calibration pose sequence, returns the head to the pallet, and releases it for continued transport to the next production station. In this variant, the locating features on the carrier pallet serve as the mechanical interface for transferring the head between the conveyor transport and the movement device, and the quick-release end-effector described above may be adapted to engage the carrier pallet's locating features rather than the head directly, simplifying the gripping mechanism.

In a second variant, the carrier pallet itself is mounted on a movement mechanism (such as a hexapod platform, a multi-axis tilt stage, or a turntable integrated into the conveyor line) that positions the head through the calibration pose sequence without removing the head from the pallet. This variant eliminates the pick-and-place operation, reducing cycle time and mechanical handling risk, at the potential cost of reduced workspace (because the pallet-mounted positioning mechanism may have fewer degrees of freedom than a dedicated robot arm).

In a third variant, the head remains stationary on the carrier pallet at the registration position, and the movable-target configuration described above (with a movement device 5020 carrying calibration targets around the head) is used instead of moving the head. This variant combines the throughput advantages of conveyor-based material handling with the mechanical simplicity of the movable-target approach. In each variant, the calibration processing unit may be networked with the production line's manufacturing execution system (MES) to receive the head's unique serial number, manufacturing lot identifier, and bill-of-materials data as the head enters the calibration station, and to transmit the calibration results (including the pass/fail status, the calibration data record, and the calibration certificate described below) to the MES as the head exits the calibration station. This integration enables the calibration results to be automatically associated with the head's production record, supporting traceability, quality control, and fleet-wide calibration data aggregation.

### E. Sensor Calibration Principles

The robot's sensors 1.2.8 (e.g., vision sensors 1.2.8.6) can be calibrated using the calibration system 3403 shown in FIGS. 3A-3C. The camera calibration procedure provides for the determination of: (i) the position and angle of the cameras relative to the installed robot component, (ii) the camera position and angle relative to one another, as said cameras are not directly coupled to the same PCB, (iii) any other intrinsic or extrinsic camera parameter(s) (e.g., focal length, skew coefficient, optical center, aperture, lens distortions) that may vary during installation or manufacturing, and/or (iv) any other camera value that may need to be calibrated to obtain accurate data from the sensors. The term “position and angle” as used herein encompasses the full six-degree-of-freedom rigid body transformation, including three translational components and three rotational components, that defines the spatial relationship between a given camera's optical frame and a designated reference frame on the robot component.

The first step in this process is to obtain the robot component (e.g., head 10.1) that includes the sensors 1.2.8 (e.g., vision sensors 1.2.8.6, and specifically the cameras 108.2.2, 108.2.4, 108.2.6, 108.2.8) that need to be calibrated. Once the robot component has been obtained, a calibration system 3403 must also be obtained. The example calibration system 3403 includes: (i) a movement device 3403.2 (e.g., a robotic arm) and (ii) a calibration fixture 3403.4. The movement device 3403.2 may have a known and pre-calibrated kinematic model, such that the joint encoder readings of the movement device 3403.2 can be converted into an end-effector pose with a known and bounded uncertainty (e.g., ±0.1 mm translational and ±0.01 degree rotational uncertainty at the TCP).

As shown in the figures, the calibration fixture 3403.4 has a fixed geometry that includes a known pattern or arrangement 3403.4.2 of markers or points 3403.4.4. The known pattern or arrangement 3403.4.2 may be any type of known pattern or arrangement, including a chessboard or checkerboard pattern. The markers or points 3403.4.4 may be any type of marker or point, including 2D planar markers such as ArUco, AprilTag, STag, CALTag, Whycon, TopoTag, CCTag, and/or any type of 3D marker. In one example, the calibration fixture 3403.4 may utilize a known pattern or arrangement 3403.4.2 that is a hybrid chessboard-fiducial board (e.g., a board that combines the benefits of a chessboard pattern with embedded uniquely-identifiable fiducial markers), or any other similar board. Such a hybrid board enables robust corner detection even when portions of the board are occluded or fall outside a camera's field of view, because each visible fiducial marker encodes a unique identifier that maps directly to a known set of chessboard corners.

Once the setup has been obtained, the data acquisition phase can then commence. During this phase, the movement device 3403.2 is programmed to move through a series of distinct poses or configurations, as shown in FIGS. 3A-3C. At each pose or configuration, the sensor 1.2.8 captures data (e.g., an image) of the calibration fixture 3403.4. It should be understood that the programmed series may include a wide variety of distinct poses or configurations to ensure observability of all calibration parameters, where observability in this context refers to the mathematical condition that the variation in observed pattern features across the set of captured poses is sufficient to uniquely determine each unknown parameter. Concurrently with each distinct pose or configuration where data is captured, the system 3403 also records the pose or configuration of the movement device 3403.2 based on its internal sensors (e.g., torque sensors, internal encoders, IMUs, etc.). Thus, the system 3403 records two data sets, wherein a first data set is the robot sensor data set and the second data set is the movement device data set.

An example of snapshots during the data acquisition phase is illustrated in FIGS. 3A-3C, which show multiple perspective views of the calibration system 3403. In this embodiment, a humanoid robot head 10.1, containing the cameras 108.2.2, 108.2.4, 108.2.6, 108.2.8 to be calibrated, is mounted on the movement device 3403.2—namely a robotic arm. The robotic arm positions the head 10.1 to face the calibration fixture 3403.4 that includes the known pattern or arrangement 3403.4.2 of markers or points 3403.4.4. FIGS. 3A-3C depict the robotic arm 3403.2 holding the head 10.1 at three different poses and orientations relative to the known pattern or arrangement 3403.4.2 of markers or points 3403.4.4. The three depicted poses may correspond to near, mid-range, and far distances from the calibration fixture 3403.4 (e.g., 0.3 m, 0.6 m, and 1.0 m respectively), and may further include tilted and rotated orientations (e.g., ±15° pitch, ±20° yaw) that cause the pattern 3403.4.2 to appear at varying positions within each camera's image plane.

The paired combination of the two data sets can then be analyzed via an external computer system. Said external computer system may first analyze the sensor data using: (i) a feature detection pipeline, which may include sub-pixel corner refinement using a gradient-based method (such as computing the intersection of edge tangent lines in a local neighborhood, with sub-pixel accuracy of ±0.1 pixel or better) and a local homography estimation, to determine the location of points, edges, lines, and/or surfaces associated with the known pattern or arrangement 3403.4.2 of markers or points 3403.4.4, and/or (ii) may use any other method of determining the location of points, edges, lines, and/or surfaces associated with the known pattern or arrangement 3403.4.2 of markers or points 3403.4.4. Once the locations of the points, edges, lines, and/or surfaces have been determined, these determined locations can be compared to the known locations of the points, edges, lines, and/or surfaces. The locations are known based off of knowing: (i) the pattern or arrangement 3403.4.2 of markers or points, (ii) the configuration of each individual marker or point 3403.4.4, (iii) the known movement of the movement device 3403.2, and/or (iv) any combination thereof. The comparison between the known locations and the determined locations may include using any known mathematical solver or optimization algorithm, which may be a non-linear least squares method, to determine the unknown transformation between the known locations and the determined locations. The solution to the unknown transformation can then be used to adjust the intrinsic parameters (e.g., focal length, skew coefficient, optical center, aperture, lens distortions) of the sensors 1.2.8 (e.g., vision sensors 1.2.8.6, and specifically the cameras 108.2.2, 108.2.4, 108.2.6, 108.2.8).

a. Sequential and Joint Calibration Pipeline Architectures

Following the intrinsic calibration for each sensor 1.2.8, the extrinsic parameters defining the kinematics of each camera's pose relative to the robot's head 10.1 and/or other cameras may be determined. The present disclosure contemplates multiple pipeline architectures for determining these parameters, each offering distinct advantages depending on the application context. In a first architecture, which represents the preferred embodiment, the intrinsic parameters, extrinsic parameters, and kinematic chain parameters are jointly estimated within a single unified optimization. This joint architecture treats all parameter types as interdependent variables and minimizes a composite cost function that simultaneously accounts for visual reprojection residuals, kinematic consistency residuals, and (where applicable) inertial and acoustic measurement residuals. The joint architecture offers the highest achievable accuracy because it exploits correlations among parameter types: an intrinsic parameter adjustment that reduces reprojection error in one camera group simultaneously informs the extrinsic parameter estimate for that group, which in turn constrains the kinematic parameters shared across all groups. This cross-parameter information sharing is absent in serial decomposition approaches and constitutes a principal advantage of the joint architecture.

To quantify this advantage, consider a calibration scenario with 8 cameras (two per group, four groups), each camera having 5 intrinsic parameters (focal length in x, focal length in y, principal point x, principal point y, and a first radial distortion coefficient), 6 extrinsic parameters per camera (3 rotational+3 translational), and a 7-DOF kinematic chain with 4 parameters per link (28 kinematic parameters). The total parameter count is 8×5+8×6+28=116 parameters. In the sequential architecture, the intrinsic calibration stage estimates 40 parameters (5 per camera×8 cameras) using only single-camera reprojection residuals; the hand-eye stage estimates 48 parameters (6 per camera×8 cameras) using only inter-pose relative transformation residuals; and the kinematic refinement stage estimates 28 parameters using only pose consistency residuals. Each stage has access to only a fraction of the total observational information. In the joint architecture, all 116 parameters (or a reduced set after eliminating redundancies) are estimated simultaneously, and every single feature observation constrains all three parameter types simultaneously, because each observation's predicted image location depends on the intrinsic model (which maps a 3D ray to a pixel), the extrinsic transformation (which maps a head-frame point to the camera frame), and the kinematic model (which maps the arm's joint angles to the head's pose in the rig frame). This shared observational coupling yields a more densely connected information matrix, resulting in tighter parameter uncertainty bounds (estimated by the inverse of the information matrix) and more reliable convergence to the globally optimal solution.

In a second architecture, the calibration pipeline may be organized as a sequence of distinct estimation stages. The intrinsic parameters of each individual camera (focal length, principal point, and lens distortion coefficients) are estimated independently using a single-camera calibration method. At this stage, each camera's images of the calibration pattern at the plurality of poses are processed in isolation to extract per-camera intrinsic parameters. The intrinsic estimation may employ a closed-form initialization based on homography decomposition of the detected pattern correspondences, followed by a non-linear refinement that minimizes the total reprojection error across all captured images for a given camera. This stage does not require knowledge of the movement device's pose data; it relies solely on the known geometry of the calibration pattern and the multiple views provided by the pose sequence.

After intrinsic calibration, the extrinsic spatial relationship between each camera's optical frame and the movement device's end-effector frame (the so-called “hand-eye” transformation) is estimated. This estimation uses the known intrinsic parameters from Stage 1 to compute per-image camera-to-pattern poses, and combines these with the movement device's pose data (from joint encoder readings) at each calibration pose. The hand-eye estimation may employ any suitable solution to the classical AX=XB formulation, where A represents the relative transformation between movement device poses at two different calibration poses, B represents the corresponding relative transformation between camera-to-pattern poses, and X represents the unknown hand-eye transformation to be estimated. The hand-eye estimation may use a closed-form solution based on simultaneous extraction of the rotational and translational components of X (e.g., decomposing the rotation component using quaternion algebra or Rodrigues' formula, then solving for the translation in closed form), or an iterative solution that minimizes the algebraic or geometric error across all pose pairs.

After the hand-eye calibration establishes an initial estimate of each camera's pose relative to the movement device, the kinematic parameters of the chain linking the movement device's joints to each camera frame may be refined. This stage may employ the iterative Jacobian-based optimization described below, using the hand-eye estimate from Stage 2 as the initial value and refining the individual link-to-link transformation parameters to minimize the residual pose error. The sequential architecture offers the advantage of modularity—each stage can be implemented, tested, and validated independently—and simplicity of implementation, as each stage solves a well-defined subproblem using established techniques. However, because each stage treats the outputs of the preceding stage as fixed inputs, errors from earlier stages propagate into later stages without the opportunity for correction. The sequential architecture may therefore achieve lower accuracy than the joint architecture, particularly when measurement noise is high or when the kinematic model has significant uncertainty. The sequential architecture may be preferred in environments where computational resources are limited, where a legacy calibration pipeline must be incrementally upgraded, or where the calibration system designer prefers a deterministic, stage-by-stage validation workflow.

In a third architecture, the sequential pipeline is used to generate an initial estimate of all parameters, and this initial estimate is then refined by a joint optimization that adjusts all parameters simultaneously. This hybrid approach combines the robustness of the sequential architecture's initialization (which avoids poor local minima by solving simpler subproblems first) with the accuracy of the joint architecture's final refinement. The hybrid architecture may be the preferred approach when the joint optimization is sensitive to initialization quality—for example, when the kinematic chain has many parameters and the cost function landscape contains multiple local minima. The choice among the joint, sequential, and hybrid architectures may be made on a per-deployment basis depending on factors such as the required calibration accuracy, the available computation time, the number of sensors to be calibrated, and the complexity of the kinematic chain. In a production calibration environment where throughput is a priority and the kinematic chain is simple (e.g., a six-axis arm with well-characterized repeatability), the sequential architecture may provide adequate accuracy with shorter computation time. In a research or prototype environment where maximum accuracy is required, the joint architecture may be preferred. The calibration system's software architecture is designed to support all three pipeline architectures through a modular parameter estimation framework in which the solver, the parameter grouping, and the cost function construction can be configured via a calibration profile stored in a configuration file.

b. Kinematic Parameter Refinement

The kinematic model linking the movement device's joints to each camera frame may employ a parameterization in which each link in the kinematic chain is characterized by a set of link-to-link transformation parameters. In one embodiment, each link is characterized by four parameters: a link length parameter a, a link twist parameter a, a link offset parameter d, and a joint angle offset parameter θ, which together define a homogeneous transformation matrix between consecutive coordinate frames along the chain. This four-parameter-per-link convention defines each inter-link homogeneous transformation as:

$${T}_{i} = [ \begin{matrix}cos {θ}_{i} & - sin {θ}_{i} cos {α}_{i} & sin {θ}_{i} sin {α}_{i} & {a}_{i} cos {θ}_{i} \\ sin {θ}_{i} & cos {θ}_{i} cos {α}_{i} & - cos {θ}_{i} sin {α}_{i} & {a}_{i} sin {θ}_{i} \\ 0 & sin {α}_{i} & cos {α}_{i} & {d}_{i} \\ 0 & 0 & 0 & 1\end{matrix} ]$$

where θᵢ is the joint angle (the sum of the commanded joint angle from the encoder and the joint angle offset to be calibrated), aᵢ is the link length, aᵢ is the link twist, and dᵢ is the link offset for the i-th link. The total forward kinematics from the base of the movement device to a camera coordinate frame is the ordered product of these per-link transformations: T_{base→camera}=T₁·T₂· . . . Tₙ·Tₘₒᵤₙₜ, where Tₘₒᵤₙₜ is the fixed transformation from the last link's frame to the camera's optical frame (which is part of the extrinsic calibration). This parameterization is a well-established convention in robotics for representing serial kinematic chains, and other equivalent parameterizations (such as product-of-exponentials, screw-axis parameterizations, or direct SE(3) parameterizations using rotation vectors and translation vectors) may be substituted without departing from the scope of the disclosure.

The iterative refinement process may begin by calculating the robot head's pose using the current kinematic parameters. This calculated pose is then compared to an actual measured pose, which may be obtained through the vision system observing a known external reference. The difference between the calculated and measured poses represents the error to be minimized. This error can be quantified by computing both position and orientation errors. The position error may be calculated as the Euclidean distance between the calculated and measured positions, while the orientation error may involve quaternion mathematics to determine the angular difference between the two orientations. In an alternative formulation, the orientation error may be expressed as an axis-angle representation or as the logarithmic map of the relative rotation matrix, both of which yield a three-component vector suitable for inclusion in a stacked error vector alongside the three-component position error. This iterative comparison and error calculation cycle allows for the progressive refinement of the alignment of the coordinate frames of the sensor systems. In other embodiments, any other known transformation may be used to solve for the extrinsic parameters of all sensors 1.2.8 contained in said robot component.

To relate the calculated error to the adjustments in the coordinate frames, the system may utilize a Jacobian matrix. The Jacobian may be constructed by treating each kinematic parameter as if it were a separate variable in the kinematic chain, resulting in a matrix with a number of columns equal to the total number of kinematic parameters being calibrated (e.g., 4 parameters×nlinks=4n columns for an n-link chain) and a number of rows equal to the dimension of the pose error vector (e.g., 6 rows for a full 6-DOF pose error comprising 3 translational and 3 rotational components). The Jacobian matrix/has the structure:

$$J = [ \begin{matrix}\frac{\partial {e}_{1}}{\partial {p}_{1}} & \frac{\partial {e}_{1}}{\partial {p}_{2}} & … & \frac{\partial {e}_{1}}{\partial {p}_{4 n}} \\ \frac{\partial {e}_{2}}{\partial {p}_{1}} & \frac{\partial {e}_{2}}{\partial {p}_{2}} & … & \frac{\partial {e}_{2}}{\partial {p}_{4 n}} \\ ⋮ & ⋮ & ⋱ & ⋮ \\ \frac{\partial {e}_{6}}{\partial {p}_{1}} & \frac{\partial {e}_{6}}{\partial {p}_{2}} & … & \frac{\partial {e}_{6}}{\partial {p}_{4 n}}\end{matrix} ]$$

where eⱼ denotes the j-th component of the 6-DOF pose error vector and pₖ denotes the k-th kinematic parameter. When multiple observation poses are stacked, the Jacobian becomes a tall matrix with 6mrows (for mposes) and 4ncolumns, and the pseudoinverse solution provides the least-squares-optimal parameter update. The iterative algorithm may then use the pseudoinverse of this Jacobian matrix to update the kinematic parameters based on the calculated pose error vector. The process of recalculating the pose and updating the parameters is repeated until the error falls below a predefined threshold, or until a maximum number of iterations has been reached without convergence, in which case the system may log a diagnostic event and report the final residual error.

Each column of the Jacobian matrix may be computed analytically or numerically. In the analytical approach, the partial derivative of the forward kinematics with respect to each kinematic parameter is derived symbolically from the chain of homogeneous transformation matrices. In the numerical approach, each partial derivative is approximated by a central finite difference:

$$\frac{\partial T}{\partial {p}_{k}} \approx \frac{T ( {p}_{k} + δ ) - T ( {p}_{k} - δ )}{2 δ} ,$$

where δ is a small perturbation (e.g., δ=10⁻⁶ for linear parameters and δ=10⁻⁶ radians for angular parameters). The analytical approach is computationally faster and avoids numerical truncation errors but requires symbolic derivation that must be re-performed when the kinematic structure changes; the numerical approach is more general and implementation-independent.

To improve the robustness of this calibration, the system may incorporate additional error detection and correction methods. These methods may include outlier detection to remove anomalous measurements, weighted least squares to prioritize more reliable data, regularization to prevent overfitting and improve solution stability, and multi-start optimization to avoid local minima and find a global solution. The outlier detection may employ a chi-squared test or a Mahalanobis distance threshold applied to each observation's reprojection residual, where observations exceeding the threshold (e.g., Mahalanobis distance >3.0, corresponding to a 99.7% confidence interval for a Gaussian error distribution) are excluded from the current optimization iteration. The multi-start optimization may sample initial kinematic parameter vectors from a distribution centered on nominal design values, with a spread determined by manufacturing tolerance specifications.

c. Factor-Graph Architecture for Joint Multi-Sensor Calibration

The calibration optimization, when employing the joint estimation architecture described above, may be formulated as a maximum a posteriori (MAP) estimation problem on a factor graph. In this formulation, variable nodes in the factor graph represent the unknown quantities to be estimated, and factor nodes represent probabilistic constraints derived from sensor measurements, kinematic models, and prior information. The variable nodes may include: (a) intrinsic parameter vectors for each camera (focal length, principal point, distortion coefficients); (b) extrinsic transformation matrices (rotation and translation) for each camera relative to a head-fixed reference frame; (c) kinematic chain parameters (link length, link twist, joint offset, joint angle offset) for each link in the kinematic chain connecting the robot arm fixture's TCP to each camera; (d) IMU bias vectors (accelerometer bias and gyroscope bias) and the spatial transformation from the IMU to the head-fixed reference frame; (e) microphone element positions relative to the head-fixed reference frame; and (f) the pose of the head at each calibration pose in the sequence (represented as a member of the SE(3) Lie group).

The factor nodes may include: (a) visual reprojection factors, each encoding the constraint that a detected calibration pattern feature in a camera image should project to its known 3D location on the calibration rig when transformed through the camera's intrinsic parameters, the camera's extrinsic transformation, and the head's pose at the time of image capture; (b) kinematic chain factors, each encoding the constraint that the head's pose should be consistent with the robotic arm's joint encoder readings propagated through the kinematic-parameter-defined forward kinematics model; (c) IMU preintegration factors, each encoding the constraint that the change in the head's pose between successive calibration poses should be consistent with the integrated IMU measurements over that time interval, accounting for estimated biases; (d) TDOA acoustic factors, each encoding the constraint that the time-difference-of-arrival of a known acoustic signal (such as a calibration tone emitted from a speaker at a known location on the calibration rig) at pairs of microphone elements should be consistent with the estimated microphone positions and the known speaker location; and (e) prior factors encoding manufacturing tolerances or nominal values for parameters that are expected to deviate only slightly from design specifications (such as kinematic parameters, which are nominally set by the mechanical design of the robot).

The MAP estimation may be performed by minimizing the sum of squared Mahalanobis-weighted residuals across all factors:

$$\hat{x} = arg {min}_{x} {\sum }_{k} {‖ {r}_{k} ( x ) ‖}_{{\sum }_{k}^{1}}^{2}$$

where x is the full state vector comprising all variable nodes, rₖ (x) is the residual function for the k-th factor, Σₖ is the covariance matrix representing the noise level of the k-th measurement, and

$${‖ \cdot ‖}_{{\sum }^{- 1}}^{2}$$

denotes the squared Mahalanobis norm r^{T}Σ⁻¹r. This minimization may be performed using iterative nonlinear least-squares methods, such as Gauss-Newton, Levenberg-Marquardt, or Dogleg trust-region methods, operating on the factor graph's variable nodes parameterized using their respective Lie algebra representations (for SE(3) pose variables) or standard Euclidean representations (for intrinsic parameters, biases, and microphone positions). The optimization may be implemented using any suitable factor-graph inference library or solver capable of operating on the structure of the calibration problem, or using a custom implementation optimized for the specific factor connectivity and variable dimensions of the humanoid head calibration problem.
d. Acoustic-Visual Cross-Modal Calibration

To calibrate the spatial relationship between the microphone array and the camera coordinate frames, the calibration rig 3000 may incorporate one or more acoustic emitters (such as piezoelectric speakers or ultrasonic transducers) positioned at known locations on the calibration rig panels 3002. During the calibration sequence, these acoustic emitters may emit predefined calibration signals (such as chirp signals, maximum-length sequences, or Golay complementary sequences) at specified times synchronized to the image capture events via a common clock source. The microphone array on the humanoid robot head 10.1 captures these acoustic signals, and the calibration processing unit estimates the time-of-arrival (TOA) of each calibration signal at each microphone element using cross-correlation or matched filtering techniques. Rather than relying exclusively on discrete geometric corner detection, the processing unit may additionally utilize the multi-angle visual data to train a continuous volumetric neural representation of the calibration rig; in this embodiment, the system iteratively adjusts the intrinsic and extrinsic parameters to minimize a comprehensive photometric rendering loss between the captured visual data and novel views synthesized from the volumetric neural representation.

From the estimated TOAs, the system computes time-difference-of-arrival (TDOA) values for each pair of microphone elements. These TDOA values, combined with the known positions of the acoustic emitters on the calibration rig, provide geometric constraints on the positions of the microphone elements relative to the calibration rig's coordinate frame. Because the positions of the cameras relative to the calibration rig are simultaneously estimated from the visual observations, the acoustic TDOA constraints are jointly optimized with the visual reprojection constraints within the same optimization framework, yielding a unified estimate of the spatial relationships among all sensor modalities in a single consistent coordinate frame. This joint optimization enables the system to exploit complementary information: the visual observations provide high-accuracy angular constraints, while the acoustic TDOA observations provide distance-dependent constraints that resolve certain spatial ambiguities, particularly along the depth direction of cameras and in regions where visual coverage is sparse. The system may thus integrate multi-modal acoustic-optical geometries by embedding synchronized ultrasonic acoustic emitters precisely registered to the optical markers on the 135-degree and 90-degree planes, allowing the identification Jacobian matrix to be populated and updated using a fused multi-modal error vector comprising both optical reprojection errors and acoustic time-difference-of-arrival calculations.

In some implementations, the acoustic calibration may also estimate the speed of sound within the calibration enclosure (treating it as an additional variable node in the optimization), compensating for temperature-dependent variations that could otherwise introduce systematic errors in the TDOA-based spatial estimates. The camera-to-microphone-array calibration may be validated by projecting an estimated sound source location into the camera image and verifying that the projection aligns with the visual location of the source within a defined pixel tolerance (e.g., less than 5 pixels).

e. IMU Registration and Temporal Synchronization

The calibration of an inertial measurement unit (IMU) mounted on the humanoid robot head 10.1 may involve estimating both the spatial transformation (rotation and translation) between the IMU and the head-fixed reference frame and any temporal offset between the IMU's measurement timestamps and the camera trigger timestamps. Temporal synchronization is key because even a small timing offset (e.g., 1 millisecond) between inertial and visual measurements can introduce significant pose estimation errors during dynamic motion. The IMU may be a six-axis or nine-axis device capable of measuring linear acceleration, angular velocity, and magnetic field orientation, and the IMU data may be time-stamped and synchronized with the visual and depth sensor data at the hardware level via a shared trigger line.

The temporal offset may be estimated within the optimization by parameterizing the IMU preintegration terms with an adjustable time shift applied to the IMU measurement stream. The optimization jointly estimates this time shift alongside all spatial parameters, using the sensitivity of the kinematic consistency constraints to temporal misalignment as the driving signal. In one embodiment, the temporal calibration may be bootstrapped by executing a fast oscillatory motion of the robotic arm at the beginning of the calibration sequence—a motion specifically designed to create large angular accelerations (e.g., peak angular velocity of 180°/s with an oscillation period of approximately 0.5 seconds) that make the optimization highly sensitive to timing errors—followed by a transition to slower, controlled motions optimized for spatial parameter estimation. This two-phase sequence separates the temporal and spatial calibration challenges, improving convergence reliability.

Finally, the computed calibration is validated and applied. The validation process may involve a series of checks that use both visual and physical feedback to assess the calibration's accuracy, including moving the robot head 10.1 to a set of validation poses that were not used during the calibration optimization and comparing the predicted camera observations against the actual sensor measurements at those poses. In other embodiments, the calibration methodology may be extended to a multi-sensor suite. For instance, a humanoid head 10.1 may be equipped with other sensors (e.g., microphones, inertial measurement units (IMUs), positioning systems, etc.). Calibrating this heterogeneous sensor array involves not only determining the intrinsic parameters of each sensor but also finding the transformations (translations and rotations) between their respective coordinate frames. For example, in a cross-modal frame alignment, the system may estimate rigid transforms between cameras and auxiliary sensors such as IMUs or microphone arrays, after time-synchronizing measurements to a common clock. Fused observations enhance robustness under motion blur, occlusion, or acoustic/visual interference. This may involve jointly optimizing visual-inertial parameters using a factor-graph or bundle-adjustment framework, with confidence scores from each modality weighting respective residuals. Similarly, the system can calibrate the spatial relationship between cameras and microphone arrays to enable audio-visual tasks like sound source localization, using techniques such as time-difference-of-arrival estimates from the microphone array to constrain camera-to-array extrinsics. These estimated transformations can be periodically revalidated and updated during operation. The periodic revalidation may be performed at a configurable interval, such as once per hour of operation or upon detection of a mechanical event (e.g., a collision or joint limit event) that may have disturbed the physical alignment of the sensors.

### F. Calibration Process

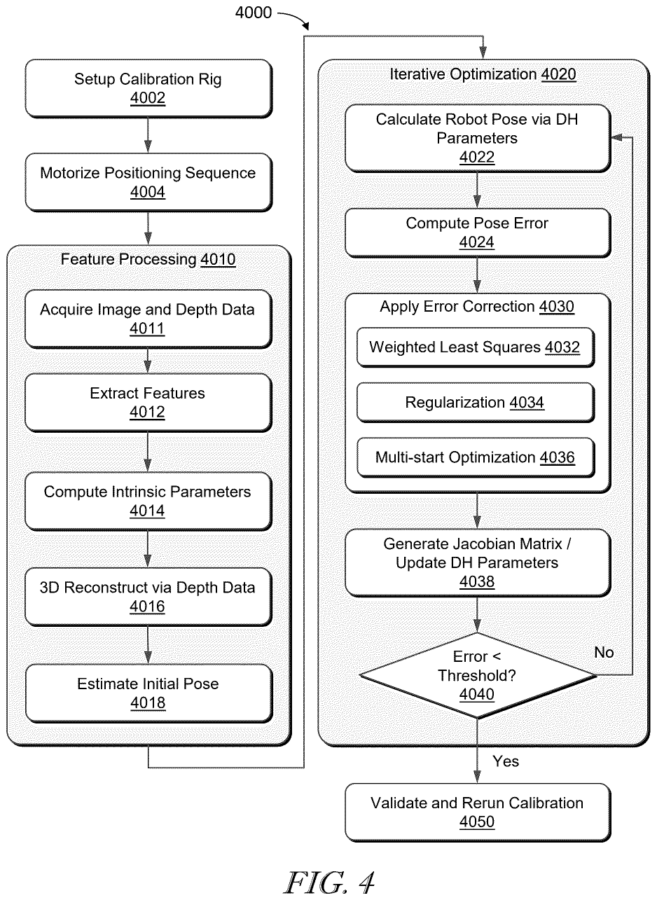

Specifically, the calibration system for the humanoid robot head integrates advanced hardware and software components to ensure precise positioning and sensing capabilities, orchestrating a structured overall calibration process 4000 illustrated in FIG. 4. This system utilizes sophisticated methodologies to enhance accuracy, reliability, and adaptability across various applications, beginning with a setup calibration rig step 4002. During this initiation phase, the robot head 10.1 to be calibrated may be securely affixed to the robot arm fixture 3010 within the structured environment of the calibration rig 3000. The affixation of the robot head 10.1 to the robot arm fixture 3010 may be accomplished via a standardized mechanical interface, such as a kinematic coupling or a bolted flange, that establishes a repeatable and rigid connection between the head 10.1 and the end-effector of the robot arm fixture 3010. A core aspect of the calibration process is the camera calibration procedure, employing the chessboard pattern or similar structured markers on the surrounding panels 3002 as a reference object.

To optimize data collection, the calibration system may include a motorized positioning sequence step 4004, enabling the robot arm fixture 3010 to move the robot head 10.1 through a predefined sequence of orientations. This automated mechanism ensures comprehensive image acquisition from multiple viewpoints, following optimized trajectories that maximize calibration coverage while minimizing the number of images to be captured. The predefined sequence may be stored as an ordered list of target joint configurations for the robot arm fixture 3010, and the motion between consecutive configurations may follow a smooth, collision-free trajectory computed by a path planner. By capturing multiple images from diverse angles and distances utilizing the various sensor groupings-such as the eye cameras 108.2.2 viewing the front-bottom panels, chin cameras 108.2.4 viewing the front-top panels, top cameras 108.2.6 viewing the overhead panels, and back cameras 108.2.8 viewing the rear panels 3002—the system establishes ground truth data based on the known dimensions and geometry of the chessboard.

Following data acquisition, the system transitions into a comprehensive feature processing block 4010, which begins with the acquired image and depth data step 4011. The depth camera calibration process may further incorporate time-of-flight measurements, enabling more precise distance calculations highly beneficial for applications such as object manipulation and complex navigation. In some embodiments, structured-light depth sensors may be used in addition to or instead of time-of-flight sensors, and the system may select between depth sensing modalities based on the distance range and ambient lighting conditions of the calibration environment. The system subsequently performs an extracting features step 4012, where deep learning-based computer vision techniques, such as convolutional neural networks (CNNs), may be leveraged to enhance chessboard corner detection, particularly in challenging conditions involving occlusions or variable lighting. The CNN-based corner detector may be trained on a dataset of synthetic and real chessboard images with annotated corner locations, and the detector may output a corner confidence map from which sub-pixel corner coordinates are extracted via a local peak-finding operation. The CNN architecture may comprise a backbone feature extractor (e.g., a ResNet-18 or MobileNetV2 architecture, providing a receptive field of at least 100×100 pixels) followed by a heatmap regression head that produces a spatial probability map at the same resolution as the input image, where each pixel value represents the predicted probability that a calibration pattern corner is centered at that pixel location. The corner coordinates are extracted by identifying local maxima in the heatmap that exceed a confidence threshold (e.g., 0.8) and refining their sub-pixel positions using a weighted centroid computation or a Gaussian fitting operation over the local neighborhood of each maximum.

Building on these extracted features, the system computes the intrinsic parameters in step 4014, allowing the precise computation of intrinsic camera values, including focal length, principal point, and lens distortion coefficients. The intrinsic parameter estimation in step 4014 may employ a closed-form initialization based on a homography decomposition of the detected pattern correspondences, followed by a non-linear refinement that minimizes the total reprojection error across all captured images for a given camera. The closed-form initialization proceeds by: (i) for each image, computing a 3×3 homography matrix Hthat maps the known 2D pattern coordinates (treating the pattern as lying on the z=0 plane) to the detected 2D image coordinates using a direct linear transformation (DLT) with at least 4 point correspondences; (ii) extracting constraints on the intrinsic parameter matrix Kfrom each homography using the relationship H=K[r₁ r₂ t], where r₁ and r₂ are the first two columns of the rotation matrix and tis the translation vector; and (iii) solving for the elements of K (focal length and principal point) from the accumulated constraints across all images using a linear system. Furthermore, to address camera lens distortion, the system implements advanced distortion correction algorithms, accounting for radial and tangential distortion to maintain visual accuracy across the entire field of view. The distortion model may include radial distortion coefficients up to the sixth order and tangential distortion coefficients to the second order, and the system may additionally model thin-prism distortion for cameras with wide-angle or fisheye lenses. For fisheye lenses with a field of view exceeding 150 degrees, the system may employ an equidistant projection model or a Kannala-Brandt generic camera model rather than the standard pinhole model with radial distortion, and the corresponding Jacobian expressions in the optimization are adapted accordingly.

The method then progresses to a 3D reconstruct via depth data step 4016, where depth information facilitates the three-dimensional reconstruction of the chessboard corners, augmenting the calibration process with vital additional spatial data points. The three-dimensional corner coordinates reconstructed in step 4016 may be fused with the two-dimensional image-based corner detections to form a hybrid observation model that constrains both the camera's intrinsic parameters and the depth sensor's range calibration parameters within a single optimization framework. Finally, within this feature processing phase, the system estimates the initial pose in step 4018, where any suitable camera pose estimation algorithm may be employed to determine the camera's position and orientation relative to the chessboard, including algorithms based on the correspondence between known three-dimensional points on the calibration pattern and their detected two-dimensional image projections; providing an initial guess of the camera's pose to the algorithm can significantly enhance the accuracy of the overall estimation. In alternative embodiments, the initial pose estimation in step 4018 may use a direct linear transformation (DLT) method, an efficient geometric correspondence algorithm, or any other suitable method for recovering a camera's pose from known 3D-to-2D point correspondences, and the choice of method may be determined based on the number of detected correspondences and the desired computation latency.

To determine the mechanical linkages of the robot arm fixture (e.g., 3010 in FIG. 2), the calibration procedure may involve defining a Jacobian matrix for the kinematic chain parameters, entering an iterative optimization block 4020. This systematic approach treats each kinematic parameter as if it were a separate variable in the kinematic chain, allowing for a more comprehensive calibration of the robot head's kinematic model within the calibration rig 3000. The iterative optimization block 4020 may operate on a stacked parameter vector comprising all kinematic chain parameters across all links of the kinematic chain from the base of the robot arm fixture 3010 through the mounting interface to each camera coordinate frame on the robot head 10.1. The process begins with a calculate robot pose via kinematic parameters step 4022, wherein a suitable robotics computation library or custom forward kinematics implementation may be utilized to represent the kinematics and dynamics of the robot head, providing functions for forward and inverse kinematics that allow calculating the robot arm's pose based on joint angles and vice versa. Initially, the current kinematic parameters may be used to calculate the robot arm's pose, leading to a compute pose error step 4024. This calculated pose may then be compared to the actual measured pose, obtained through external sensors or vision systems, yielding a difference that represents the error needing minimization. To quantify this error, the system may compute both position and orientation errors; the position error may be calculated as the Euclidean distance between the calculated and measured end-effector positions, while the orientation error may be more complex, potentially involving quaternion mathematics to determine the angular difference between the calculated and measured orientations. In some embodiments, the position error and the orientation error may be weighted relative to one another using a tunable scaling factor (e.g., a weight ratio of 1 mm: 0.01 radian, meaning that 1 mm of position error is treated as equivalent in cost to 0.01 radian of orientation error), allowing the optimization to preferentially reduce one component of the error based on the specific application's sensitivity to translational versus rotational inaccuracies.

To resolve these quantified errors, the system employs an apply error correction step 4030, utilizing sophisticated data processing techniques designed to handle discrepancies and achieve precise calibration. To ensure data integrity, the system may employ statistical techniques for outlier detection to identify and remove measurements that deviate significantly from expected values, helping prevent erroneous data from skewing calibration results. The outlier detection in step 4030 may operate in a two-pass manner, where a first pass identifies measurements with residuals exceeding a threshold (e.g., 3× the median absolute deviation) relative to the median absolute deviation, and a second pass re-estimates the model parameters after excluding the identified outliers. The system may further refine the data through a weighted least squares step 4032, assigning weights to different measurements based on their estimated reliability, an approach that allows the algorithm to prioritize more accurate measurements during the parameter update process. To prevent overfitting and improve the stability of the solution, the system may execute a regularization step 4034, incorporating regularization terms in the optimization process to balance between minimizing the calibration error and maintaining reasonable parameter values. The regularization step 4034 may apply a Tikhonov regularization penalty that penalizes large deviations of the kinematic parameters from their nominal design values, where the regularization weight Areg is selected via a cross-validation procedure or an L-curve analysis. The regularized cost function takes the form:

$$C ( p ) = {\sum }_{i} {w}_{i} {‖ {r}_{i} ( p ) ‖}^{2} + {λ}_{reg} {‖ p - {p}_{nominal} ‖}^{2}$$

where p is the kinematic parameter vector, pₙₒₘᵢₙₐₗ is the nominal design parameter vector, rᵢ is the residual for the i-th observation, wᵢ is its weight, and λ_{reg} controls the strength of the regularization. A typical value of λ_{reg} may be in the range of 10⁻⁴ to 10⁻², selected to prevent individual kinematic parameters from deviating beyond physically plausible ranges while allowing the optimization sufficient freedom to fit the observations.

Additionally, a multi-start optimization step 4036 may be utilized, running the calibration algorithm multiple times with different initial parameter values to avoid local minima and find the best global solution. The system may also use a portion of the collected data for calibration and reserve another portion for cross-validation, an approach that can help assess the generalization capability of the calibrated model and detect potential overfitting. The cross-validation partition may be selected such that the validation set includes poses that span the full workspace of the robot arm fixture 3010, ensuring that the calibrated model is evaluated over a representative range of configurations.

a. Initialization Strategies for Iterative Optimization

The present disclosure contemplates multiple strategies for initializing the iterative kinematic parameter optimization, each offering distinct tradeoffs between implementation complexity and convergence performance. In a first initialization strategy, the iterative optimization is initialized with the nominal design values of the kinematic parameters as specified in the mechanical design documentation (e.g., CAD models) of the humanoid robot head and the calibration rig. The nominal values represent the intended dimensions and angular relationships of each link in the kinematic chain and are readily available without any per-unit measurement, historical data analysis, or machine learning model. This strategy is the simplest to implement and requires no infrastructure beyond the mechanical design specifications. The nominal values are stored in a configuration file or database associated with the robot head's design revision, and the calibration system retrieves these values at the start of each calibration session. When combined with the multi-start optimization described in step 4036 (in which the optimization is run multiple times with initial values perturbed around the nominal values according to a spread determined by manufacturing tolerance specifications), the nominal-value initialization provides a robust starting point that is sufficient for convergence in the majority of production units.

In a second initialization strategy, the iterative optimization is executed a plurality of times (e.g., 5 to 20 independent runs), each time initialized with kinematic parameter values drawn randomly from a distribution centered on the nominal design values and bounded by the manufacturing tolerance range for each parameter. For example, if the nominal link length for a given link is 50.0 mm with a manufacturing tolerance of ±0.5 mm, the random initialization may draw the initial link length from a uniform distribution over the interval [49.5, 50.5] mm or from a Gaussian distribution with mean 50.0 mm and standard deviation 0.17 mm (such that ±3σ spans the tolerance range). After all runs complete, the system selects the solution with the lowest composite error metric as the final calibration result. This multi-start strategy provides strong robustness against convergence to local minima without requiring any historical calibration data or trained models, at the cost of increased computation time proportional to the number of random starts.

In a third initialization strategy, the calibration system maintains a database of final converged kinematic parameters from previously calibrated units of the same design revision. The initial values for a new unit are set to the statistical centroid (e.g., the mean or median) of the parameter values in this database, optionally weighted by recency or manufacturing lot proximity. This strategy leverages the observation that units manufactured in similar conditions tend to have similar kinematic parameter values, and therefore the empirical centroid is likely to be closer to the true values for a new unit than the nominal design values (which do not account for systematic manufacturing biases). As the number of calibrated units grows, the empirical prior converges toward the true systematic bias of the manufacturing process, progressively improving initialization quality.

In a fourth initialization strategy, a machine learning model trained on calibration data from a plurality of previously calibrated components may be used to predict initial values of at least a subset of the calibration parameters for a new, uncalibrated unit. The machine learning model may receive as input manufacturing metadata (such as lot identifiers, serial numbers, component supplier codes), environmental conditions (ambient temperature, humidity), and optionally a small subset of raw sensor observations captured at a single initial pose, and may output predicted initial values for the kinematic parameters, camera intrinsic parameters, or both. This prediction is then used as the starting point for the iterative optimization.

The machine learning model may comprise a feedforward neural network with one or more hidden layers, a Gaussian process regression model, a gradient-boosted decision tree ensemble, or any other suitable supervised regression model. The training dataset may be collected from a fleet of previously calibrated units, with each training example comprising the input features (manufacturing metadata, environmental conditions) and the corresponding final converged calibration parameters as the target output. The model may be trained using a mean squared error loss function with regularization to prevent overfitting, and may be periodically retrained as additional calibration records become available.

The machine-learning-based initialization may reduce the number of optimization iterations required for convergence and may reduce the probability of convergence to local minima, particularly for units with large manufacturing deviations. However, this strategy requires a sufficient volume of historical calibration data for training and incurs additional infrastructure complexity (model training, deployment, and maintenance). The nominal-value, random-multi-start, and empirical-prior strategies described above are available as simpler alternatives that do not require a trained model, and the calibration system may be configured to use any of these strategies based on the availability of historical data and the deployment context.

The choice of initialization strategy may be configured by the operator or by an automated selection logic in the calibration system's software. In one embodiment, the calibration system defaults to nominal-value initialization with multi-start optimization for the first N units of a new design revision (where N is a configurable threshold, e.g., N=50), then transitions to empirical-prior initialization once a statistically significant database of calibration results has been accumulated, and optionally transitions to machine-learning-based initialization once a trained model achieves a validation accuracy criterion.

With the corrected data configured, the iterative algorithm may use the previously defined Jacobian matrix during a generate Jacobian matrix and update kinematic parameters step 4038. The Jacobian matrix may describe how small changes in these parameters affect the end-effector position and orientation, where each column of the Jacobian corresponds to the partial derivative of the pose error vector with respect to a single kinematic parameter. The update may be performed using the equation:

$$Δ θ = {J}^{+} Δ x$$

where the change in kinematic parameters Δθ equals the pseudoinverse of the Jacobian matrix J⁺ multiplied by the pose error vector Δx. The system may apply this update by adding the calculated change to the current DH parameters using the equation:

$${θ}_{n e w} = {θ}_{c u r rent} + Δ θ$$

The software architecture is modular and extensible, comprising dedicated modules for image processing, feature extraction, and mathematical optimization that collaboratively refine calibration results utilizing techniques such as bundle adjustment and non-linear least squares methods. After updating the parameters, the system proceeds to an error less than threshold decision block 4040. If the error is not below the threshold (e.g., a composite RMS reprojection error of less than 0.3 pixels and an RMS kinematic pose error of less than 0.1 mm), the system may recalculate the robot's pose using the new kinematic parameters and compare it again with the measured pose, repeating iteratively until the error falls below a predefined threshold or a maximum number of iterations (e.g., 100) is reached. During these cycles, the motorized positioning system may integrate adaptive control algorithms, dynamically adjusting movements based on real-time feedback to optimize calibration efficiency and minimize motion.

Once the system achieves an acceptable error margin, it proceeds to a validate and rerun calibration step 4050. This validation step may involve moving the robot head to predefined positions and comparing the measured positions with the expected positions based on the calibrated model, where any discrepancies may be used to refine the calibration further or to assess the calibration accuracy. The predefined validation positions in step 4050 may include poses that place one or more calibration panels 3002 at the periphery of a camera's field of view, testing the calibration accuracy at extreme viewing angles where lens distortion effects are most pronounced. Error estimation and validation procedures play a significant role in maintaining calibration accuracy, as the system integrates reprojection error analysis, cross-validation techniques, and uncertainty propagation methods to quantify calibration precision, while confidence intervals for calibration parameters help determine when recalibration is needed.

User-friendliness is a key design principle, with a graphical user interface guiding operators through the calibration process and providing real-time feedback, including visualizations of detected chessboard corners, reprojection error maps, and parameter convergence plots, enabling operators to assess calibration quality efficiently. The graphical user interface may display a color-coded overlay on each camera's live video feed, where detected corner locations are marked with indicators whose color varies from green (reprojection error <0.3 pixels) to yellow (0.3-1.0 pixels) to red (>1.0 pixels) based on the local reprojection error magnitude, allowing the operator to visually identify regions of the image where calibration accuracy may be suboptimal. In some embodiments, the graphical user interface may further display a three-dimensional rendering of the calibration rig 3000 with the estimated camera frustums superimposed, allowing the operator to verify the spatial consistency of the multi-camera extrinsic calibration.

b. Calibration Data Record and Certificate Specification

Upon successful completion of the calibration process (i.e., all camera groups pass the validation checks in step 4050), the calibration system generates a structured calibration data record and a calibration certificate for the calibrated component. The calibration data record and certificate serve as a machine-readable, cryptographically authenticated digital record of the calibration results, supporting traceability, fleet management, over-the-air parameter deployment, and quality control. The calibration certificate is a compact, digitally signed document derived from the calibration data record. The certificate may be generated as follows: (a) a cryptographic hash (e.g., SHA-256) of the full calibration data record is computed; (b) the hash is digitally signed using a private key held securely by the calibration system (e.g., in a hardware security module (HSM) or a trusted platform module (TPM)); (c) the signed hash, together with the calibration system's public key certificate, the record_id, the component_serial_number, the calibration_timestamp, and the overall_pass_fail result, are packaged into a compact certificate document. The certificate may be verified by any party possessing the calibration system's public key certificate, ensuring the authenticity and integrity of the calibration results. The calibration certificate enables downstream systems (such as the robot's onboard firmware, a fleet management server, or a regulatory compliance database) to verify that a component's calibration results have not been tampered with and were produced by an authorized calibration system.

The calibration data record and certificate may be stored in one or more of the following locations: (a) a non-volatile memory on the humanoid robot head 10.1 itself (such as an EEPROM, a flash memory chip, or an embedded secure element), allowing the robot's onboard systems to read the calibration parameters at boot time without network connectivity; (b) a calibration database server maintained by the manufacturer, indexed by the component_serial number and the record_id, enabling fleet-wide queries (e.g., “retrieve the most recent calibration record for all units in manufacturing lot L-2025-0042”) and statistical process control analysis; (c) a manufacturing execution system (MES) database, linked to the component's production record for traceability; and (d) a cloud-based fleet management system, enabling remote retrieval and over-the-air deployment of calibration parameters to fielded robots. The data record may additionally be exported in human-readable formats (such as a PDF calibration report or a printable label with a QR code linking to the full record) for manual inspection and physical archival purposes.

### G. Per-Camera-Group Calibration Health Monitoring

Self-diagnostic capabilities can further enhance system robustness by continuously monitoring calibration accuracy during periodic checks or routine operation; by detecting gradual performance degradation, the system can trigger timely recalibration, maintaining optimal perception capabilities and preventing errors due to miscalibration. The self-diagnostic module may compute a running average and variance of the reprojection error over a sliding window of recent observations (e.g., the most recent 1000 observations), and may compare these statistics against baseline values established during the most recent successful calibration to detect statistically significant drift. The self-diagnostic module may maintain, for each camera group (e.g., eye cameras 108.2.2, chin cameras 108.2.4, top cameras 108.2.6, rear cameras 108.2.8), an independent set of calibration health metrics derived from the camera group's observations during routine operation. These metrics may include: (a) the mean and variance of the reprojection error computed when known objects (such as calibration markers permanently affixed to the robot's workspace, or features in a pre-mapped environment) are observed; (b) the temporal rate of change of the estimated extrinsic transformation between the camera group and the head-fixed reference frame, as computed by a sliding-window visual odometry or SLAM pipeline; (c) the consistency between the camera group's depth estimates and those produced by other sensor modalities (such as depth cameras or stereo pairs from other camera groups); and (d) the stability of the estimated intrinsic parameters (focal length, principal point, distortion coefficients) as computed by an online intrinsic recalibration algorithm operating on natural scene features.

For each metric, the self-diagnostic module maintains a baseline value established during the most recent successful calibration. The module then applies statistical tests to detect departures from this baseline that exceed predefined significance levels. In one embodiment, the module may apply a cumulative sum (CUSUM) control chart to the time series of per-camera-group reprojection errors, detecting systematic drift in calibration quality before the degradation becomes large enough to be apparent in individual measurements. The CUSUM statistic may be computed as Sn=max(0, Sₙ₋₁+(xₙ−μ₀)−k), where xₙ is the n-th reprojection error observation, μ₀ is the baseline mean, and k is a slack parameter (typically set to half the expected shift magnitude); an alarm is triggered when Sₙ exceeds a threshold h. In another embodiment, the module may apply a chi-square test to the residuals of the visual odometry system, testing the hypothesis that the residuals are consistent with the noise model assumed during calibration. Rejection of this hypothesis for a specific camera group, while other groups pass the test, indicates localized calibration degradation in the affected group.

a. Zone-Specific Recalibration Triggering and Execution

When the self-diagnostic module detects that calibration health metrics for a specific camera group have degraded beyond a predefined threshold (e.g., mean reprojection error exceeding 1.5 pixels, or CUSUM alarm triggered), the module may initiate a zone-specific recalibration procedure that re-estimates only the parameters associated with the degraded camera group while holding the parameters of all other camera groups fixed at their previously validated values. This partial recalibration may be executed either by returning the humanoid robot to the calibration rig 3000 for a targeted recalibration sequence focusing on the affected zone's panels, or by performing an in-field recalibration using environmental features or portable calibration targets.

In the rig-based zone-specific recalibration, the robotic arm fixture 3010 may execute an abbreviated pose sequence that emphasizes views of the panels corresponding to the degraded camera group, rather than performing the full multi-zone calibration sequence. This abbreviated sequence may comprise as few as five to ten poses, compared to the 20 to 100 poses used for a full calibration, significantly reducing recalibration downtime. The optimization is configured to treat the parameters of unaffected camera groups as fixed constants, reducing the dimensionality of the estimation problem and improving convergence speed.

In the in-field zone-specific recalibration, the humanoid robot may observe known environmental features (such as calibration markers permanently installed in its operating environment, or features in a pre-mapped 3D model of the workspace) using the degraded camera group, and re-estimate the affected camera group's extrinsic parameters using these observations. The decision between rig-based and in-field recalibration may be made autonomously by the self-diagnostic module based on the severity of the detected degradation: small drifts (within a predefined correction range, e.g., extrinsic rotation drift of less than 0.5 degrees and translation drift of less than 2 mm) may be addressed in-field, while larger degradations or suspected intrinsic parameter changes (which call for high-quality calibration target observations) may trigger a return to the calibration rig.

b. Degradation Classification and Root Cause Inference

The self-diagnostic module may further classify detected calibration degradation according to its probable root cause, enabling targeted corrective action. For example, a gradual, monotonic drift in the extrinsic parameters of a single camera group (e.g., a linear drift rate exceeding 0.01 degrees per 100 operating hours) may indicate mechanical loosening or creep in the camera's mounting hardware, suggesting a maintenance action (physical inspection and retightening) in addition to recalibration. A sudden, discrete shift in extrinsic parameters (e.g., a step change exceeding 0.5 degrees occurring within a single observation window) may indicate a mechanical shock or impact event, which may be confirmed by correlating the timing of the parameter shift with accelerometer readings from the IMU. A gradual increase in reprojection error variance without a corresponding shift in extrinsic parameters may indicate optical degradation (e.g., lens contamination, condensation, or aging), suggesting a cleaning or replacement action rather than recalibration. By classifying degradation types and inferring root causes, the self-diagnostic module enables the humanoid robot or its operator to take appropriate corrective action rather than merely re-running the calibration procedure, which would not address underlying mechanical or optical issues. In this manner, the self-diagnostic routine may further distinguish between calibration drift attributable to mechanical wear in the robot head's joints and drift attributable to shifts in the calibration rig's own geometry, enabling targeted corrective action.

The calibration system also incorporates advanced techniques to improve accuracy and efficiency, where machine learning algorithms may be employed to analyze historical calibration data, identifying trends that facilitate predictive adjustments and reduce the frequency of full recalibrations, and a neural network may even be trained to predict optimal initial kinematic parameters based on raw sensor data. Parallel processing techniques may be incorporated into software modules to improve computational efficiency, reducing calibration times and enabling more frequent checks without significantly affecting the robot's operational availability.

c. Temperature-Dependent Calibration Parameter Modeling

In some implementations, the calibration system may account for temperature-dependent variations in sensor and mechanical parameters. Camera intrinsic parameters, particularly the focal length, are sensitive to temperature changes because thermal expansion alters the physical distance between the lens elements and the image sensor. For a typical camera module, a 10° C. temperature change may induce a focal length shift on the order of 0.1 to 1.0 pixels, which, if uncompensated, directly degrades calibration accuracy. To address this, the calibration rig 3000 may include one or more temperature sensors (such as thermocouples, resistance temperature detectors, or infrared pyrometers) that measure the ambient temperature within the calibration enclosure and/or the surface temperature of the humanoid robot head 10.1 during calibration. The calibration processing unit may incorporate a thermal model that relates each temperature-sensitive calibration parameter (e.g., focal length, lens distortion coefficients, and mechanical dimensions affecting kinematic parameters) to the measured temperature, using either a physics-based model (e.g., linear thermal expansion coefficients for each material in the optical and mechanical path) or an empirically derived polynomial model fitted to calibration data collected at multiple temperatures. For example, the focal length as a function of temperature may be modeled as f (T)=f₀+β₁(T−T₀)+β₂(T−T₀)₂, where f₀ is the focal length at the reference temperature T₀, and β₁ and β₂ are empirically determined coefficients.

During calibration, the measured temperature may be recorded alongside the calibration results in the calibration data record. During subsequent operation, the self-diagnostic module may monitor the head's temperature (e.g., via an on-board temperature sensor) and apply the thermal model to adjust the stored calibration parameters to the current operating temperature, maintaining calibration accuracy across the operating temperature range without making recalibration a prerequisite. If the temperature departs outside the range over which the thermal model has been validated (e.g., outside the range of 15° C. to 40° C.), the self-diagnostic module may flag this condition and, depending on the severity of the excursion, either apply an extrapolated correction with an increased uncertainty estimate or trigger a recalibration.

The integration of calibrated components in the humanoid robot head may significantly enhance overall system performance, as proper calibration of individual elements, such as cameras, joint actuators, and sensors, may contribute to improved functionality across various aspects of the robot's operation. In some cases, the calibrated visual system may enable more accurate object recognition and tracking, while the precise alignment of cameras and depth sensors may allow for enhanced depth perception, improving the robot's ability to navigate complex environments and interact with objects at varying distances. The calibration of joint actuators and kinematic parameters may result in more natural and fluid head movements, enhancing the robot's ability to mimic human-like gestures and improving its capacity for non-verbal communication in social interactions. The enhanced depth perception resulting from calibrated stereo camera pairs may enable the robot to construct dense point cloud representations of its surroundings, facilitating real-time obstacle avoidance and path planning with sub-centimeter spatial resolution.

In some cases, the calibration process may include joint angle calibration, moving each joint through its full range of motion and recording corresponding encoder readings to establish accurate relationships between encoder values and actual joint angles. The joint angle calibration may employ a lookup table or a polynomial mapping function to correct for non-linearities in the encoder-to-angle relationship, such as those caused by gear backlash, coupling compliance, or non-uniform encoder scale factors. The overall head positioning and movement calibration may incorporate data from multiple sensors, including inertial measurement units (IMUs), cameras, and joint encoders, where sensor fusion techniques may be employed to combine these data sources and achieve a more robust calibration. The sensor fusion may be implemented via an extended Kalman filter or an unscented Kalman filter that maintains a state vector comprising the head's position, orientation, linear velocity, angular velocity, and sensor bias terms, and the filter may be tuned using the noise characteristics established during the calibration of each individual sensor modality.

The integration of calibrated IMUs with the visual system may enable more stable gaze tracking and image stabilization, enhancing the robot's ability to maintain visual focus on objects of interest even when the robot's body is in motion. The calibrated auditory system, working in conjunction with the calibrated visual system, may improve the robot's ability to localize sound sources accurately, enhancing performance in tasks such as speaker identification or selective attention in noisy environments. In some cases, the calibration of tactile sensors in conjunction with joint position sensors may result in more accurate proprioception, enabling the robot to better understand its head's position in space and interact with its environment safely and precisely. The tactile-proprioceptive fusion may allow the robot to detect and compensate for external contact forces applied to the head structure, preventing damage to the sensors and maintaining calibration integrity during physical human-robot interaction.

The calibration system is designed to be highly repeatable and may include provisions for periodic recalibration to account for potential drift or wear in the robot's components over time, with integration of properly calibrated components contributing to improved energy efficiency. Precise calibration may reduce motions and corrections that serve no functional purpose, potentially leading to lower power consumption and extended operational time. Additional reference objects with varying geometries and textures may complement the chessboard pattern, ensuring comprehensive calibration across diverse lighting conditions and surfaces, which enhances the robot's ability to perceive and interact accurately in varied environments. These additional reference objects may include planar targets with randomized dot patterns, three-dimensional calibration artifacts with known corner and edge coordinates, and diffuse reflectance standards for radiometric calibration of the cameras' intensity response.

### H. Machine Learning for Predictive Calibration

a. Training Data Collection and Feature Engineering

The machine learning module for predictive calibration may operate on a training dataset collected from a fleet of previously calibrated humanoid robot heads. For each calibrated unit, the training dataset may include: (a) the final converged kinematic parameters and camera intrinsic/extrinsic parameters; (b) the manufacturing lot identifiers and serial numbers of the camera modules, structural components, and actuator assemblies installed in that unit; (c) environmental conditions during calibration (ambient temperature, humidity, and illumination level as measured by sensors in the calibration rig); (d) the initial (nominal/design) kinematic parameters; (e) the number of iterations for the calibration optimization to converge; and (f) the final residual error metrics (reprojection error, kinematic error, and overall cost). The feature engineering process may derive additional predictive features from this raw data, including: the deviation of final kinematic parameters from nominal values (capturing systematic manufacturing biases); the variance of kinematic parameters across units within the same manufacturing lot (capturing lot-level consistency); and temporal trends in kinematic parameter values across sequentially manufactured units (capturing gradual tooling wear or process drift).

b. Neural Network Architecture and Training Procedure

In one embodiment, the predictive calibration model may comprise a feedforward neural network with an input layer receiving the manufacturing metadata and environmental conditions, two or more hidden layers with rectified linear unit (ReLU) activation functions (e.g., two hidden layers of 128 and 64 units respectively), and an output layer producing predicted initial kinematic parameters and camera intrinsic parameter estimates for a new, uncalibrated unit. The network may be trained using a mean squared error loss function computed between the predicted initial parameters and the final converged parameters from the training dataset, with L2 regularization applied to the network weights to prevent overfitting. The training procedure may use stochastic gradient descent with an adaptive learning rate schedule (such as the Adam optimizer with an initial learning rate of 10\hat{ }−3, training on 80% of the historical calibration records and validating on the remaining 20%. Hyperparameter selection (number of hidden layers, layer width, regularization coefficient, learning rate) may be performed via cross-validation. The CNN used for chessboard corner detection may be periodically retrained using a combination of archived calibration images and newly collected data, allowing the model to adapt to gradual changes in sensor characteristics or rig appearance.

In another embodiment, the predictive model may comprise a Gaussian process regression (GPR) model that provides not only point estimates of the initial kinematic parameters but also uncertainty estimates (confidence intervals) for each predicted parameter. These uncertainty estimates may be used to set the initial covariance matrices for the prior terms in the optimization, enabling the optimization to appropriately weight the ML-predicted initial values relative to the measurement-derived constraints: parameters predicted with high confidence receive tighter priors, while parameters predicted with low confidence receive looser priors that allow the optimization greater freedom to adjust them.

c. Operational Benefits of Predictive Initialization

By providing informed initial parameter values (rather than nominal design values or random initialization) to the iterative calibration optimization, the predictive calibration module may reduce the number of optimization iterations for convergence by 30% to 70%, depending on the accuracy of the predictions and the magnitude of the per-unit manufacturing variations. This reduction in iteration count directly translates to reduced calibration time per unit, which is a significant benefit in production environments where calibration throughput affects overall manufacturing cycle time. Additionally, by starting the optimization closer to the true parameter values, predictive initialization may reduce the probability of convergence to local minima—a risk that is mitigated in the conventional approach by multi-start optimization (running the optimization multiple times with different random initializations), which further multiplies the calibration time. With predictive initialization, a single optimization run is more likely to converge to the global minimum, potentially eliminating the need for multi-start optimization in routine calibration and reserving it only as a fallback for units whose predicted parameters prove insufficiently accurate.

Furthermore, the predictive model's accuracy may serve as a quality indicator for the manufacturing process itself. If the predicted initial parameters for a new unit deviate significantly from the final converged parameters after calibration, this discrepancy may indicate an anomaly in the unit's manufacture (such as a misassembled component, an out-of-specification part, or an installation error) that warrants further inspection. The calibration system may flag such units for quality review, providing an additional layer of manufacturing quality assurance beyond the calibration accuracy checks themselves.

### I. Simulation-Based Calibration Pre-Validation

In some cases, the calibration procedure may be tested and refined in a virtual environment before implementation on the physical robot; for example, a photorealistic 3D rendering engine may be used to validate the calibration algorithms and assess their effectiveness under various simulated conditions. This approach may allow for rapid iteration and optimization of the calibration process without risking damage to the physical hardware, providing a controlled environment where various scenarios can be tested, such as different lighting conditions, object configurations, and robot movements. The virtual environment may model the optical characteristics of the cameras, including sensor noise, rolling shutter effects, and lens vignetting, to produce synthetic images that closely approximate the output of the physical sensors.

a. Virtual Calibration Environment Configuration

The virtual environment may be implemented using a real-time 3D rendering engine that provides photorealistic rendering of the calibration rig, the humanoid robot head, and the sensor systems. The virtual environment may be configured as follows: (a) a 3D model of the calibration rig 3000, including geometrically accurate representations of all planar panels 3002, their angular arrangements, and the calibration patterns printed on their surfaces, is imported or constructed within the rendering engine; (b) a 3D model of the humanoid robot head 10.1, including the physical geometry of all camera mounting locations, lens positions, and sensor aperture orientations, is imported from the same CAD models used for manufacturing; (c) virtual camera sensors are instantiated at each camera mounting location, configured with camera models that include parameterizable focal length, principal point, radial distortion (at least k1, k2, k3 coefficients), tangential distortion (p1, p2 coefficients), and optionally higher-order distortion models; (d) virtual depth sensors are instantiated alongside the cameras, configured with noise models that approximate the characteristics of the physical depth sensors (such as time-of-flight noise as a function of distance, multi-path interference artifacts, and depth-dependent systematic biases); (e) a virtual IMU is instantiated at the IMU's mounting location, configured with noise models including white noise, bias instability, and bias random walk for both the accelerometer and gyroscope axes; and (f) virtual microphone elements are instantiated at the microphone array's element positions, configured with acoustic propagation models and timing noise models for TDOA estimation.

b. Simulation Workflow and Validation Metrics

The simulation workflow may proceed as follows. First, the virtual robotic arm executes the candidate calibration pose sequence, and the virtual sensors generate synthetic measurement data (images, depth maps, IMU readings, TDOA values) at each pose. This synthetic data is contaminated with noise drawn from the configured sensor noise models. Second, the calibration processing pipeline processes the synthetic data using identical algorithms to those used on real data-feature detection, intrinsic estimation, optimization, and kinematic parameter refinement. Third, the calibration results (estimated intrinsic parameters, extrinsic transformations, kinematic parameters) are compared against the ground-truth values known from the simulation configuration.

The validation metrics may include: (a) absolute parameter recovery error for each estimated parameter (the difference between the estimated value and the ground-truth value); (b) reprojection error computed using the estimated parameters on a held-out set of synthetic observations not used during calibration; (c) sensitivity analysis, in which each noise model parameter is varied independently and the resulting change in calibration accuracy is measured, identifying which noise sources have the greatest impact on calibration quality; and (d) convergence basin analysis, in which the calibration optimization is initialized at varying distances from the ground-truth parameters to determine the size of the convergence basin—the range of initial parameter errors from which the optimization reliably converges to an acceptable solution.

This simulation-based pre-validation enables the calibration system designer to optimize the calibration pose sequence, the feature detection algorithm parameters, the optimization structure and noise model tuning, and the convergence criteria before any physical hardware is fabricated. It also enables systematic testing of edge cases and failure modes (such as partial panel occlusion, camera failure during the sequence, extreme lighting conditions, or large manufacturing deviations) that would be difficult or costly to reproduce on physical hardware.

c. Synthetic Data Augmentation for Machine Learning Models

The Simulator may also be used to generate synthetic data for training machine learning models that support the calibration process, generating large datasets of simulated camera images, depth maps, and joint angle readings, which may be used to improve the robustness and accuracy of the calibration algorithms. The synthetic training data may be augmented with domain randomization techniques, varying parameters such as texture appearance, ambient lighting color temperature, and calibration target surface reflectance to encourage the trained models to generalize across a broad range of real-world conditions. For the predictive calibration model, the simulation may generate thousands of synthetic calibration runs with systematically varied manufacturing deviations (kinematic parameter offsets drawn from the expected manufacturing tolerance distributions), environmental conditions (temperature-induced focal length shifts, lighting level variations), and sensor noise realizations, producing a diverse training dataset that supplements the historical calibration records from physical units. For the CNN-based chessboard corner detection model, the simulation may generate synthetic images of calibration patterns under diverse lighting conditions, partial occlusions, and viewing geometries, with automatically generated ground-truth corner locations for supervised training. This simulation-augmented training may improve the robustness and generalization of the ML models, particularly during the early production phase when the number of physical calibration records is small.

Monte Carlo simulations may be utilized for advanced error estimation, providing a deeper understanding of calibration uncertainties and their potential impact on the robot's performance across various tasks. Augmented reality (AR) features may enhance the user interface, guiding operators in optimal positioning of reference objects through visual overlays, thereby improving calibration accuracy. Designed for modularity and adaptability, the calibration system supports integration of new techniques and sensor types, accommodating evolving humanoid robot designs and application-specific customizations, while predictive maintenance capabilities may be integrated to analyze calibration trends over time to forecast component degradation and proactively schedule maintenance, ensuring consistent system performance with minimal downtime. The predictive maintenance module may employ regression analysis or a recurrent neural network trained on historical calibration parameter trajectories to predict the time at which a given sensor or joint parameter is expected to drift beyond its acceptable tolerance, enabling preemptive corrective action.

### J. Alternative Embodiments

In one alternative embodiment of the calibration system configured for a humanoid robot head, the system utilizes a camera module comprising at least one RGB camera and one depth camera, which is mounted directly on the robot head. A motorized positioning system moves the head through a predefined sequence of orientations relative to a calibration rig. This rig features multiple reflective boards uniquely arranged to provide optimal reference geometry, with at least two boards positioned at a 90-degree angle and two others at a 135-degree angle relative to each other. The reflective boards may have a matte or semi-matte surface finish to reduce specular reflections that could otherwise saturate camera pixels and degrade corner detection performance. A processing unit captures multiple images from various angles and distances, utilizing computer vision algorithms-such as edge detection, corner refinement, and outlier rejection—to detect and extract chessboard corners from the rig. The system computes intrinsic camera parameters, including focal length, principal point, and lens distortion coefficients, while simultaneously calculating a three-dimensional reconstruction of the corners using depth data. Calibration is further refined by generating a Jacobian matrix that treats each kinematic chain parameter as a separate variable in the kinematic model, iteratively updating these parameters to minimize errors between calculated and measured robot head poses.

Enhancing this process, the system may employ machine learning algorithms, such as a trained convolutional neural network (CNN), to analyze historical calibration data and improve chessboard corner detection even in challenging lighting conditions or partial occlusions. The CNN may be periodically retrained using a combination of archived calibration images and newly collected data, allowing the model to adapt to gradual changes in sensor characteristics or rig appearance. A user interface module provides real-time feedback, displaying visualizations of detected corners, reprojection error maps, and parameter convergence plots. Furthermore, a self-diagnostic module continuously monitors calibration accuracy during routine operation, automatically triggering recalibration procedures if statistical performance degradation is detected. The self-diagnostic module may log each triggered recalibration event along with the statistical metrics that prompted it, enabling post-hoc analysis of component wear rates and environmental factors affecting calibration stability.

In another embodiment, the humanoid robot head calibration system leverages a similar structural setup, but emphasizes the use of reflective boards that specifically feature a highly visible chessboard pattern printed directly on their surfaces. The printed chessboard pattern may be produced using a high-resolution digital printing process on a dimensionally stable substrate to ensure that the corner spacing remains within a specified tolerance (e.g., ±0.05 mm) over a range of temperature (10° C. to 40° C.) and humidity (20% to 80% RH) conditions. As the motorized positioning system maneuvers the head through its programmed orientations, the processing unit applies advanced computer vision techniques to precisely extract the features of this printed chessboard pattern. The system utilizes this data to compute intrinsic camera parameters and reconstruct the three-dimensional coordinates of the chessboard corners using the integrated depth camera.

The kinematic calibration in this embodiment is achieved by generating the kinematic parameter Jacobian matrix and iteratively updating it based on precise pose error calculations. To maintain long-term accuracy without manual intervention, this system incorporates a robust self-diagnostic routine. By employing statistical analysis of positioning errors gathered during both periodic system checks and routine operation, the module can detect gradual performance degradation. If this degradation exceeds a predefined threshold, the system autonomously initiates a recalibration procedure, simultaneously displaying real-time visualizations and progress to the operator via the user interface module. In this embodiment, the self-diagnostic routine may further distinguish between calibration drift attributable to mechanical wear in the robot head's joints and drift attributable to shifts in the calibration rig's own geometry, enabling targeted corrective action.

In yet another embodiment, the calibration architecture is adapted for a broader range of robotic devices, such as industrial robot arms, mobile manipulators, robotic end-effectors, drone-mounted gimbal cameras, and autonomous vehicle sensor turrets. This system utilizes a generalized imaging module equipped with standard and depth cameras, working in conjunction with an automated positioning mechanism that dynamically adjusts the device's position relative to a calibration target. The calibration target may be a portable or wall-mounted assembly that can be installed in a variety of workspaces, and the automated positioning mechanism may be a turntable, a linear rail, or an articulated arm distinct from the device under calibration. The target consists of a pattern of known geometry applied to multiple reflective boards arranged in the strategic 90-degree and 135-degree configurations.

The system's processing unit executes a calibration algorithm that identifies these pattern features using edge detection and outlier rejection, enabling the computation of intrinsic camera parameters and a full 3D spatial reconstruction. Unlike systems limited to specific robotic head models, this setup generates a Jacobian matrix treating each generalized kinematic parameter of the robotic device as a discrete variable within the kinematic chain. Through iterative updates and error calculations between the theoretical and measured device poses, the system thoroughly validates the calibration. Continuous monitoring ensures that any statistical drift in positioning triggers an automatic recalibration, with all ongoing progress and results presented on a connected display unit.

Another alternative embodiment provides a comprehensive system for calibrating diverse sensor arrays on a generalized robotic apparatus. In this configuration, the robotic apparatus operates within a specialized, room-scale calibration environment containing multiple reference objects with known spatial relationships. These reference objects comprise planar surfaces uniquely positioned at 90-degree and 135-degree angles, each bearing a distinct pattern of known geometry. The room-scale calibration environment may include environmental control systems for regulating ambient lighting intensity (e.g., controllable to ±10 lux), color temperature (e.g., adjustable between 3000K and 6500K), and air temperature (e.g., controllable to ±0.5° C.), thereby reducing variability in sensor measurements caused by uncontrolled environmental factors.

A motion control system autonomously maneuvers the robotic apparatus within this environment while a computational unit processes data continuously collected from visual and depth sensors. The computational unit extracts these distinct pattern features to compute essential intrinsic parameters and generate a three-dimensional reconstruction of the calibration environment. It then refines the robotic apparatus's kinematic model using the Jacobian matrix approach, iteratively updating kinematic variables to resolve errors between calculated and actual apparatus poses. By comparing measured positions with the calibrated model's expectations, the system verifies its accuracy. An output interface dynamically communicates the calibration status and outcomes, while an integrated diagnostic module ensures ongoing reliability by detecting gradual performance degradation and autonomously commanding recalibration when needed.

In a further embodiment, a highly integrated calibration apparatus is provided for complex robotic systems, utilizing a multi-sensor module that incorporates a visual sensor, a depth sensor, and an Inertial Measurement Unit (IMU). This sophisticated system interacts with a calibration setup comprised of multi-angled planar surfaces featuring distinct patterns that combine geometric shapes with high-contrast markers. The IMU may be a six-axis or nine-axis device capable of measuring linear acceleration, angular velocity, and magnetic field orientation, and the IMU data may be time-stamped and synchronized with the visual and depth sensor data at the hardware level via a shared trigger line. An actuation mechanism precisely orients the robotic system relative to these specific markers, allowing the system to capture a rich dataset of visual, depth, and spatial orientation information.

The inclusion of the IMU allows the apparatus to continuously detect micro-orientation changes during the calibration routines, fusing this motion data with two-dimensional image captures and distance measurements. A dedicated data processing unit extracts the high-contrast features, computes the visual sensor's intrinsic parameters, and reconstructs the physical setup in three dimensions. Following the iterative update of kinematic parameters via a Jacobian matrix, the system establishes a highly accurate, multi-modal kinematic model. A user-facing interface delivers comprehensive feedback, and upon completion, the system seamlessly transitions into a self-monitoring state, capable of automatically rectifying any operational drift by triggering recalibration protocols when predefined error thresholds are exceeded.

In still another embodiment, the calibration system may be configured for deployment in a field environment outside of a dedicated calibration facility. In this configuration, a portable calibration fixture comprising one or more foldable or collapsible planar panels bearing calibration patterns is transported to the robot's operational site and assembled in a known geometric arrangement. The robot head 10.1 may be mounted on the robot's own body rather than on a separate robot arm fixture 3010, and the robot's own kinematic chain may be used to position the head 10.1 through the sequence of calibration poses, with the robot's joint encoders providing the movement device data set. To compensate for the potentially lower positional accuracy of the robot's own joints compared to a dedicated calibration-grade robot arm fixture, the system may apply a simultaneous localization and calibration algorithm that jointly estimates the robot's joint offsets and the camera calibration parameters. The field calibration embodiment may further employ a fiducial marker affixed to the portable calibration fixture at a known location, and an independent measurement device such as a laser tracker or a total station may observe this fiducial marker to provide an external ground truth position that anchors the optimization.

In yet another alternative embodiment, calibration data from a fleet of deployed humanoid robots may be aggregated to continuously improve the predictive calibration machine learning model. Each robot in the fleet may periodically transmit its calibration results (final parameter values, residual error metrics, environmental conditions, and self-diagnostic health metrics) to a centralized server or cloud-based aggregation system. The aggregation system may retrain or fine-tune the predictive calibration model using this expanded dataset, incorporating calibration outcomes from diverse operating environments, temperature ranges, and mechanical wear states. The updated model may then be distributed back to the fleet (and to the production calibration system) to improve the accuracy of predictive initialization for future calibration events.

To address privacy and data sensitivity concerns in deployments where calibration data may reveal information about the robot's operating environment or activities, the federated learning approach may employ privacy-preserving techniques such as differential privacy (adding calibrated noise to the transmitted calibration data) or federated averaging (transmitting only model gradient updates rather than raw calibration data). These techniques enable the fleet to benefit from collective calibration experience while limiting the disclosure of individual robot operating details. In a further alternative embodiment, the planar surfaces of the calibration rig 3000 may comprise electronically controlled display panels (such as LCD screens, e-ink displays, or OLED panels) rather than printed static patterns; the primary embodiment utilizes statically printed high-contrast markers on the surrounding panels, yet the present disclosure contemplates advanced alternative configurations to dynamically adapt to varying focal lengths and optical conditions. These display panels may dynamically generate calibration patterns that are optimized in real time based on feedback from the calibration processing pipeline, and the displays may be configured to dynamically alter the projected geometric calibration patterns in precise temporal synchronization with the frame capture rate of the multi-sensor perception array, thereby mitigating moiré interference. For example, if the processing unit detects that a particular camera group has insufficient corner detections in a specific image region (due to lens vignetting, partial occlusion, or unfavorable viewing geometry at the current pose), the display panel corresponding to that camera group's zone may increase the density of calibration features in the undersampled region, switch to a higher-contrast pattern, or display a different pattern type (e.g., switching from a chessboard to a circle grid or asymmetric marker pattern) that is better suited to the current observation conditions.

The dynamic pattern generation may be governed by an adaptive algorithm that, at each pose in the calibration sequence, evaluates the spatial distribution and quality of detected features across each camera group's image, computes a feature quality score for each image region, and commands the display panels to adjust their patterns to improve feature quality in underperforming regions before the next image capture. This closed-loop, adaptive pattern generation may significantly improve calibration robustness in the presence of optical imperfections, environmental lighting variations, or manufacturing variability in camera module performance, ensuring that every camera group receives a sufficient quantity and spatial distribution of high-quality calibration observations regardless of incidental adverse conditions. In a related configuration, the display panels comprising high-density OLED or MicroLED panels may be combined with the multi-angled enclosure geometry (90-degree and 135-degree arrangements) described herein, such that the adaptive pattern generation and the optimized angular geometry work in concert to maximize calibration observation quality across all camera groups and all poses.

In yet a further embodiment, the calibration system may support over-the-air parameter update delivery, wherein the calibration parameters computed for a particular robot head unit are packaged into a digitally signed calibration data file (conforming to the calibration data record schema described above) and transmitted to the robot head 10.1 via a wireless communication interface. The robot's onboard firmware may validate the digital signature of the calibration data file using the certificate verification procedure described above, apply the updated intrinsic and extrinsic parameters to the camera driver software, and confirm successful application by performing a brief self-test that captures an image of a known reference and verifies that the reprojection error falls within the acceptable range. This over-the-air update capability enables centralized calibration management across a fleet of humanoid robots, where a calibration server maintains a database of each unit's calibration history (stored as calibration data records indexed by component_serial_number) and schedules recalibrations based on usage telemetry and the predictive maintenance forecasts generated by the calibration system's diagnostic module.

### K. Industrial Application

The present disclosure provides for a system and method for autonomous robot self-calibration which solves technical problems inherent in prior art calibration techniques. Pre-existing calibration methods for humanoid robots rely on external metrology equipment, such as laser trackers or physical jigs, which require precise manual alignment. These methods are factually observed to be time-consuming, prone to operator error and inconsistency, and present significant scalability challenges due to the high cost and logistical burden of deploying specialized external hardware. Furthermore, such conventional methods typically provide a static calibration at a single point in time, failing to account for kinematic drift that occurs during a robot's operational life due to component wear and environmental factors. The disclosed system provides a direct technical solution to these problems by enabling a humanoid robot to calibrate its own kinematic structure using only its integrated sensory equipment, specifically its onboard cameras and proprioceptive sensors (e.g., joint encoders). By creating a self-contained, closed-loop system, this approach eliminates the requirement for external measurement devices, making the robot independent of specialized fixtures or controlled environments for maintaining its own accuracy.

The system comprises a specialized computer vision model, termed a Bipedal Spatial Perception Model (BSPM), which is trained to identify and determine the three-dimensional position of predefined keypoints on the robot's own body, such as on its end-effectors and feet. The BSPM is generated using a training dataset that is primarily composed of synthetic image data. This data is created by systematically and automatically varying a wide range of configurable parameters (e.g., lighting intensity and direction, robot pose, camera angles, and background textures) from a core dataset of real-world images and CAD models. This process yields a highly robust perception model specifically tailored to the robot's unique physical morphology, enabling reliable keypoint detection under diverse and unpredictable real-world operating conditions.

The calibration process involves the physical operation of the robot and the synchronized processing of data from its physical sensors. The robot is controlled to move its limbs through a series of predetermined poses, which are specifically designed to present the keypoints to the cameras across a full range of joint motion. During these movements, two distinct and time-correlated datasets are captured concurrently: a set of measurement data is recorded from the robot's internal joint encoders, representing the robot's kinematic-based configuration according to its current model, and a set of image data is captured by the robot's head-mounted cameras observing its own moving limbs, representing the ground-truth physical configuration. The BSPM processes the captured image data to generate a perceived robot configuration by determining the precise 3D positions of the keypoints in the camera's frame of reference. An optimization algorithm then mathematically compares the perceived keypoint locations with the kinematic-based keypoint locations derived from the joint encoder data. The objective of this algorithm is to find the specific numerical offset values, or revised biases, for the robot's kinematic model that minimize the discrepancy between the visual reality and the model's predictions. These revised values are then applied directly to the robot's control system, which physically corrects for inaccuracies in the robot's movements by updating its internal understanding of its own geometry.

This autonomous self-calibration process results in a number of factual technical improvements. It provides a repeatable and rapid calibration method that can be performed without manual supervision, for instance, as an automated routine during a robot's daily startup sequence. It can also be performed continuously in the background during normal operation, allowing for real-time correction of calibration drift caused by factors like thermal expansion from motor heat, mechanical wear in gears, or minor impacts. The resulting improvement in the robot's kinematic accuracy leads to tangible and significant improvements in the performance of downstream physical tasks. By correcting small errors that would otherwise compound along the kinematic chain, the system ensures greater navigation accuracy and more precise, reliable manipulation of objects.

As referenced throughout this disclosure, the processing unit that executes the calibration pipeline is a physical computing system comprising specific hardware components selected and configured for the computational demands of multi-sensor calibration. The processing unit is not a general-purpose abstract computing concept but a concrete hardware apparatus with defined subsystems. The processing unit may comprise one or more multi-core central processing units (CPUs) providing general-purpose computation. In one embodiment, the CPU is a 64-bit x86-architecture processor with at least eight physical cores and a clock frequency of at least 3.0 GHz, providing the sequential processing throughput needed for iterative optimization algorithms (such as the Jacobian-based kinematic parameter refinement described herein). The CPU may include a hardware floating-point unit supporting double-precision (64-bit) IEEE 754 arithmetic, which is used for all kinematic and optimization computations to maintain numerical precision across the iterative refinement cycles. In alternative embodiments, the CPU may be an ARM-architecture processor, a RISC-V processor, or any other instruction set architecture capable of executing the calibration software.

The processing unit may further comprise one or more graphics processing units (GPUs) providing massively parallel computation capability. The GPU may be used to accelerate computationally intensive operations within the calibration pipeline, including but not limited to: image preprocessing (debayering, white balance, gamma correction), feature detection (CNN-based corner detection forward inference), depth map generation (stereo matching or structured-light decoding), reprojection error computation across thousands of feature observations simultaneously, and Jacobian matrix construction and singular value decomposition for large-scale optimization problems. In one embodiment, the GPU contains at least 2,048 CUDA-compatible or equivalent parallel processing cores and at least 8 GB of high-bandwidth memory (HBM or GDDR6). The GPU may interface with the CPU via a PCIe Gen4 or Gen5 bus providing at least 16 GB/s bidirectional bandwidth, ensuring that image data and intermediate computation results can be transferred between CPU and GPU with minimal latency. The GPU-accelerated reprojection error computation may achieve a throughput of at least 10 million point-reprojection evaluations per second, enabling the joint optimization across all cameras and all poses to complete within seconds rather than minutes.

In some embodiments, the processing unit may include an FPGA module configured to implement time-critical, deterministic processing tasks such as: hardware trigger generation for synchronized multi-sensor capture (generating trigger pulses with sub-microsecond jitter across all cameras, depth sensors, IMUs, and acoustic emitters); real-time image data marshalling and timestamping (assigning a common-clock timestamp to each sensor frame at the moment of acquisition); and low-latency feature detection preprocessing (such as Sobel edge filtering or Harris corner response computation) that feeds into the GPU-accelerated CNN corner detector. The FPGA may be programmed in a hardware description language (such as VHDL or Verilog) and may be reconfigurable to support different sensor interface protocols (such as MIPI CSI-2, GigE Vision, USB3 Vision, or Camera Link) depending on the cameras installed in the humanoid robot head.

The processing unit may include a memory hierarchy comprising: (a) high-speed volatile memory (such as DDR5 SDRAM) with at least 32 GB capacity, used for storing captured image frames (e.g., eight cameras×2 megapixels×3 channels×100 poses=approximately 4.8 GB of raw image data per calibration session), intermediate computation buffers, and optimization state vectors during the calibration session; (b) non-volatile solid-state storage (such as NVMe SSD) with at least 1 TB capacity, used for persistent storage of captured calibration data sets, calibration results, historical calibration records, and machine learning model weights; and (c) optional external network-attached storage for archival of calibration records across a fleet of robot units.

The processing unit may include one or more communication interfaces for connectivity with external systems, including: (a) a high-speed wired data interface (such as 10 Gigabit Ethernet or USB 3.2) connecting the processing unit to the humanoid robot head's sensor hub for real-time image and sensor data transfer; (b) a control interface (such as EtherCAT, PROFINET, or a proprietary serial protocol) connecting the processing unit to the controller of the robot arm fixture 3010 or other movement device for commanding pose sequences and receiving joint encoder readings; (c) a display interface (such as HDMI or DisplayPort) for the graphical user interface; and (d) a wireless communication interface (such as Wi-Fi 6E or Bluetooth 5.x) for over-the-air calibration parameter delivery and fleet telemetry.

As used in the claims, the “controller” operatively coupled to the movement device is a physical control system comprising a dedicated real-time processor (such as an ARM Cortex-R series processor, a Texas Instruments C2000 microcontroller, or a Beckhoff industrial PC running a real-time operating system such as EtherCAT-synchronized TwinCAT, Xenomai, or PREEMPT_RT Linux) that executes the motion control firmware responsible for commanding the movement device through the calibration pose sequence. The controller receives high-level pose commands from the processing unit (specifying target joint angles or Cartesian positions for each pose in the calibration sequence), converts these commands into low-level motor drive signals (such as pulse-width-modulated voltage commands or current commands to servo motor amplifiers), monitors joint encoder feedback to achieve closed-loop position control, and reports the achieved joint configuration back to the processing unit as pose data. The controller may implement a real-time servo loop operating at a rate of at least 1 kHz, with a commanded-to-achieved position tracking error of less than 0.05 millimeters under quasi-static conditions. The controller may be a separate physical unit (such as a robot controller cabinet) or may be integrated into the processing unit's hardware platform as a dedicated real-time co-processor. The controller may further implement a trajectory interpolation module that converts the discrete sequence of commanded poses into smooth, continuous joint-space trajectories (e.g., using cubic spline or quintic polynomial interpolation) that respect the movement device's velocity, acceleration, and jerk limits, ensuring smooth motion that minimizes vibration and settling time at each pose. This explicit hardware architecture ensures that the “processing unit” and “controller” recited in the claims are understood as concrete physical systems with defined computational, memory, and communication capabilities—not as abstract functional designations.

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one of skill in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system. A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution. A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/342,470, 19/357,879, 19/352,959, 19/355,393, 19/321,022, 19/355,531, 19/355,786, 19/357,879, 19/358,414, 19/362,617, 19/565,007 and 19/565,304; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/705,802, 63/706,779, 63/763,209, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A calibration system for calibrating one or more sensors contained in a component of a robot, the calibration system comprising:
a calibration fixture having a surface bearing a pattern of known geometry;
a movement device separate from the robot and configured to be removably secured to the component of the robot, and wherein the component includes one or more sensors coupled to said component;
a controller operatively coupled to the movement device, the controller configured to cause the movement device to effect relative positioning between the component and the calibration fixture at each of a plurality of distinct poses; and
a processing unit communicatively coupled to the one or more sensors and to the movement device, the processing unit configured to:
receive, at each of the plurality of distinct poses, sensor data captured by the one or more sensors while the component is at that pose, and pose data indicative of a configuration of the movement device at that pose; and
determine one or more calibration parameters of the one or more sensors based at least in part on a comparison between (i) locations of features of the pattern as determined from the sensor data and (ii) known locations of the features on the calibration fixture, using the pose data to relate the sensor data across the plurality of distinct poses.

2. The calibration system of claim 1, wherein the component is a head of a humanoid robot and the one or more sensors comprise a plurality of cameras arranged in a plurality of distinct camera groups, each camera group having a respective field of view oriented in a different direction relative to the head.

3. The calibration system of claim 2, wherein the calibration fixture comprises a plurality of planar surfaces arranged in distinct spatial zones, each spatial zone positioned to fall within the field of view of a respective one of the plurality of distinct camera groups such that, at each of the plurality of distinct poses, each camera group observes calibration pattern features on at least one planar surface within its corresponding spatial zone.

4. The calibration system of claim 3, wherein at least two of the plurality of planar surfaces are arranged at approximately 90 degrees relative to each other and at least two other of the plurality of planar surfaces are arranged at approximately 135 degrees relative to each other.

5. The calibration system of claim 1, wherein the one or more sensors comprise at least one visual sensor and at least one depth sensor, and the processing unit is further configured to compute a three-dimensional reconstruction of the features of the pattern using depth data acquired from the at least one depth sensor and to incorporate the three-dimensional reconstruction into the determination of the one or more calibration parameters.

6. The calibration system of claim 1, wherein the calibration fixture comprises a plurality of surfaces, each surface bearing a respective pattern of known geometry, and wherein each respective pattern includes a unique identifier enabling the processing unit to unambiguously associate detected features with their corresponding surface on the calibration fixture.

7. The calibration system of claim 1, wherein the one or more calibration parameters comprise intrinsic parameters and extrinsic parameters, and wherein the processing unit is configured to determine the intrinsic parameters and the extrinsic parameters within a single unified optimization that jointly estimates both parameter types using the sensor data and the pose data acquired across the plurality of distinct poses.

8. The calibration system of claim 1, further comprising: a compliance sensor interposed between the movement device and the component, the compliance sensor configured to measure forces and torques exerted on the component during the effecting of relative positioning; wherein the processing unit is further configured to detect, based on measurements from the compliance sensor, whether the component has been subjected to a force or torque exceeding a predefined threshold during any of the plurality of distinct poses, and to exclude sensor data and pose data associated with any pose at which the predefined threshold was exceeded from the determination of the one or more calibration parameters.

9. The calibration system of claim 1, wherein the movement device comprises an articulated arm having at least six degrees of freedom, and wherein the controller is further configured to: execute a first sweep of poses drawn from a coarse grid spanning a workspace of the movement device to acquire an initial set of sensor data and pose data; compute, based on the initial set of sensor data and pose data, an information-gain map identifying regions of the workspace in which additional poses would most reduce uncertainty in the one or more calibration parameters; and execute a second sweep of poses concentrated in the identified regions to acquire a supplemental set of sensor data and pose data; wherein the processing unit determines the one or more calibration parameters using the sensor data and pose data from both the first sweep and the second sweep.

10. A method of calibrating one or more sensors contained in a component of a robot, the method comprising:
removably securing the component to a movement device that is separate from the robot, and wherein the component includes one or more sensors coupled to said component;
effecting, by the movement device, relative positioning between the component and a calibration fixture having a surface bearing a pattern of known geometry at a plurality of distinct poses, each pose placing at least a portion of the pattern within a field of view of at least one of the one or more sensors;
at each of the plurality of distinct poses, acquiring sensor data from the one or more sensors and recording pose data indicative of a configuration of the movement device at that pose;
determining, by a processing unit, one or more calibration parameters of the one or more sensors based at least in part on a comparison between (i) locations of features of the pattern as determined from the sensor data and (ii) known locations of the features on the calibration fixture, using the pose data to relate the sensor data across the plurality of distinct poses; and
applying the determined one or more calibration parameters to at least one of: (a) a memory associated with the component, (b) a memory associated with the robot, or (c) a calibration database indexed by an identifier of the component or the robot.

11. The method of claim 10, wherein the component is a head of a humanoid robot and the one or more sensors comprise a plurality of cameras arranged in a plurality of distinct camera groups including at least two of: eye cameras, chin-mounted cameras, top-mounted cameras, or rear-facing cameras.

12. The method of claim 11, wherein the calibration fixture comprises a plurality of planar surfaces positioned in distinct spatial zones corresponding to respective fields of view of the plurality of distinct camera groups, and wherein the effecting relative positioning comprises moving the component through the plurality of distinct poses such that each camera group simultaneously observes calibration pattern features on at least one planar surface within its corresponding spatial zone.

13. The method of claim 10, wherein the determining comprises the processing unit executing instructions stored in a non-transitory memory to jointly estimate intrinsic parameters, extrinsic parameters, and kinematic chain parameters within a factor-graph optimization in which:
variable nodes represent at least the intrinsic parameters, the extrinsic parameters, and kinematic parameters of a kinematic model relating the movement device to the one or more sensors; and
factor nodes encode constraints derived from at least visual reprojection residuals and kinematic chain consistency residuals;
and wherein the jointly estimated parameters are output and applied as the one or more calibration parameters.

14. The method of claim 13, wherein the one or more sensors further comprise at least one inertial measurement unit, and wherein the factor-graph optimization further comprises IMU preintegration factor nodes encoding constraints derived from inertial measurements acquired during transitions between the plurality of distinct poses, and the variable nodes further represent an IMU bias vector and a spatial transformation between the inertial measurement unit and a reference frame fixed to the component.

15. The method of claim 10, further comprising, prior to the determining, applying a machine-learning model trained on calibration data from a plurality of previously calibrated components to predict initial values of at least a subset of the one or more calibration parameters, and wherein the determining uses the predicted initial values as a starting point for an iterative optimization.

16. The method of claim 10, further comprising selecting the plurality of distinct poses by evaluating, for a set of candidate poses, an observability metric derived from a Fisher information matrix computed over the one or more calibration parameters, and selecting the plurality of distinct poses to optimize the observability metric subject to at least one constraint selected from: joint limits of the movement device, collision avoidance between the component and the calibration fixture, or minimum feature visibility for each of the one or more sensors.

17. The method of claim 10, further comprising, prior to the removably securing, validating a calibration algorithm used in the determining by:
instantiating virtual representations of the calibration fixture, the component, and the one or more sensors in a rendering engine, the virtual representations configured with known ground-truth calibration parameters and sensor noise models;
generating synthetic sensor data and synthetic pose data by simulating the plurality of distinct poses in the simulated environment;
executing the calibration algorithm on the synthetic sensor data and synthetic pose data to produce estimated calibration parameters; and
comparing the estimated calibration parameters against the known ground-truth calibration parameters to verify that estimation errors fall below acceptance criteria.

18. The method of claim 10, further comprising, after the determining, effecting relative positioning between the component and the calibration fixture at one or more validation poses distinct from the plurality of distinct poses used during determination of the one or more calibration parameters, computing a validation metric from sensor data acquired at the one or more validation poses using the determined one or more calibration parameters, and accepting or rejecting the determined one or more calibration parameters based on whether the validation metric satisfies an acceptance criterion.

19. The method of claim 10, further comprising: monitoring, during the effecting relative positioning, a thermal state of the one or more sensors by reading one or more temperature sensors disposed on or proximate to the component; associating a temperature reading with each of the plurality of distinct poses; and wherein the determining further comprises incorporating the temperature readings into the determination of the one or more calibration parameters by modeling at least one of the intrinsic parameters as a function of temperature, such that the one or more calibration parameters include temperature-dependent correction terms enabling compensation of thermally induced calibration drift during subsequent operation of the robot.
